(19) United States
(12) Patent Application Publication
(10) Pub. No.: US 2016/0371808 A1
(43) Pub. Date: Dec. 22, 2016

(54) METHOD AND APPARATUS FOR CONTROLLING DISPLAY OPERATIONS

(71) Applicant: ARM LIMITED, Cambridge (GB)

(72) Inventors: Daren CROXFORD, Cambridge (GB); Jayavarapu Srinivasa RAO, Cambridge (GB)

(21) Appl. No.: 15/254,280

(22) Filed: Sep. 1, 2016

Related U.S. Application Data
(63) Continuation-in-part of application No. 12/588,461, filed on Oct. 15, 2009.

(30) Foreign Application Priority Data
Sep. 25, 2009 (GB) 0916924.4

(51) Int. Cl. G06T 1/20; G06T 1/60

(52) U.S. Cl. CPC G06T 1/20; G06T 1/60

(57) ABSTRACT

A graphics processing system generates output frames for display on a display. Comparison and control hardware of a display controller of the graphics processing system operates to compare successive output frames that are being generated for display, and then controls one or more aspects of the way in which the display of the output frames is carried out. In one embodiment, the display device or a frame buffer is partially updated (refreshed) by the display controller on the basis of comparisons of composited output frames.

The technology described herein relates to the controlling of display operations where an output is to be displayed on a display device such as an LCD display, and in particular to such arrangements where a data processing system, such as a graphics processing system, is providing an output to be displayed on a display device.

As is known in the art, the output of an, e.g., graphics processing system that is to be displayed is usually written to a so-called “frame buffer” in memory when it is ready for display. The frame buffer is then read by a display controller and output to a display device (which may, e.g., be a screen or printer) for display.

The reading of the frame buffer and its provision to the display device is a relatively expensive operation. For example, LCD displays are typically refreshed at a constant high rate typically between 60-70 Hz. Each such “refresh” involves reading the complete frame buffer from memory and writing the contents to the display. This involves, inter alia, a lot of power hungry memory and display accesses.

The bandwidth of reading from and writing to the frame buffer and writing to the display can also be a significant system bandwidth and power cost, particularly in the case of high definition (HD) displays.

One known technique for trying to reduce the power consumption of display operations is to reduce the display refresh rate under the control of the application that is generating the output to be displayed. For example, if the application knows that the output frame has not changed or will not change for a while, it can signal the display controller to defer, or reduce the rate of, refreshing the display. However, these arrangements rely on the application and/or operating system itself being able to perform the necessary display control.

The Applicants believe therefore that there remains scope for improvements to display operations in data processing systems.

An embodiment of the technology described herein comprises a method of operating a data processing system in which a stream of output frames to be displayed is generated by the data processing system for display on a display device, the method comprising:

the data processing system comparing output frames to be displayed, and controlling at least one aspect of the way in which the output frames are provided for display on the display device on the basis of the comparison.

Another embodiment of the technology described herein comprises a data processing system in which a stream of output frames to be displayed is generated by the data processing system for display on a display device, the system comprising:

a display device for displaying an output frame; and

processing circuitry for comparing output frames to be displayed and for controlling at least one aspect of the way in which the output frames are provided for display on the display device on the basis of the comparison.

Another embodiment of the technology described herein comprises a display control apparatus for use in a data processing system in which successive output frames to be displayed are generated by the data processing system for display on a display device, the apparatus comprising:

processing circuitry configured to compare output frames to be displayed, and to control at least one aspect of the way in which the output frames are provided for display on the display device on the basis of the comparison.

In some embodiments, a display controller of the data processing system may compare the output frames to be displayed and control at least one aspect of the way in which the output frames are provided for display on the display device on the basis of the comparison (i.e. the above-mentioned processing circuitry may form part of a display controller).

Thus, another embodiment of the technology described herein comprises a method of operating a data processing system in which a stream of output frames to be displayed is generated by the data processing system for display on a display device, the method comprising:

a display controller of the data processing system comparing output frames to be displayed, and controlling at least one aspect of the way in which the output frames are provided for display on the display device on the basis of the comparison.

Another embodiment of the technology described herein comprises a data processing system in which a stream of output frames to be displayed is generated by the data processing system for display on a display device, the system comprising:

a display device for displaying an output frame; and

a display controller comprising processing circuitry for comparing output frames to be displayed and for controlling at least one aspect of the way in which the output frames are provided for display on the display device on the basis of the comparison.

Another embodiment of the technology described herein comprises a display controller for use in a data processing system in which successive output frames to be displayed are generated by the data processing system for display on a display device, the display controller comprising:

processing circuitry configured to compare output frames to be displayed, and to control at least one aspect of the way in which the output frames are provided for display on the display device on the basis of the comparison.

The technology described herein may comprise the display controller reading in, e.g. from a frame buffer, output frames generated by the data processing system for display and/or generating composited output frames to be displayed from plural input layers (frames) generated by the data processing system. The technology described herein may also comprise writing (e.g. composited) output frames generated by the data processing system (e.g. by the display controller) to be displayed to a frame buffer.

Thus, according to another embodiment of the technology described herein comprises a method of operating a data processing system in which a stream of output frames to be displayed is generated by the data processing system and written to a frame buffer for display on a display device, the method comprising: the data processing system comparing output frames to be displayed, and controlling at least one aspect of the way in which the output frames are provided for display on the display device on the basis of the comparison.

According to another embodiment of the technology described herein comprises a data processing system comprising:

a data processor for generating a stream of output frames to be displayed;

a frame buffer for storing an output frame to be displayed;

a write controller for writing an output frame generated by the data processor to the frame buffer;

a display device for displaying an output frame;

a display controller for reading an output frame from the frame buffer and for providing it to the display device for display; and

processing circuitry for comparing output frames to be displayed and for controlling at least one aspect of the way in which the output frames are provided for display on the display device on the basis of the comparison.

According to another embodiment of the technology described herein comprises a display control apparatus for use in a data processing system in which successive output frames to be displayed are generated by the data processing system and written to a frame buffer for display on a display device, the apparatus comprising:

processing circuitry configured to compare output frames to be displayed, and to control at least one aspect of the way in which the output frames are provided for display on the display device on the basis of the comparison.

The technology described herein relates to arrangements in which a data processing system, such as a graphics processing system, produces a stream of output frames to be displayed on a display device, such as a screen. However, in the technology described herein, one or more aspects of the way in which the display of output frames on the display device is carried out is controlled on the basis of a comparison of output frames to be displayed. As will be discussed further below, the Applicants have recognised that by comparing output frames, a measure, for example, of the extent to which different output frames differ from each other can be derived, and, moreover, that this information can then be used to advantageously control the operation for displaying the output frames in use.

For example (and again as will be discussed further below), if it is found that the output frames or parts thereof are not changing, the update or refresh rate of the display device can be reduced or the display device or a frame buffer can be partially updated without significantly degrading the image as seen by the user, thereby reducing the power, etc., that will be consumed by the display operation.

Similarly, and again as will be discussed further below, it would be possible to alter the format of the stored output frame data (e.g. as between a lower quality format requiring fewer bits of data and a higher quality format requiring more bits of data) depending upon the rate at which the display is found to be changing. This could then be used, e.g., to control the format that the output frames are stored in the frame buffer (and hence the bandwidth needed for the display operations) dynamically in use.

Thus, the technology described herein can be used to reduce significantly the power consumed and memory bandwidth used for display operations, in effect by facilitating the identification of opportunities to perform the display operations in a more efficient manner.

Moreover, in contrast to the prior art schemes discussed above, the technology described herein does not depend upon any application or operating system operation, will work for a variety of sources (and not, e.g., only for specific applications), can provide a more immediate and dynamic response and control, and can provide greater power and bandwidth savings than known prior art systems.

The aspect or aspects of the way in which the output frames are provided for display that is or are controlled in response to the output frame comparisons in the technology described herein can relate to any suitable and desired aspect of the process for displaying the output frames. For example, as discussed above, it could (and, indeed, in an embodiment does) relate to the update or refresh rate of the display and/or to the partial updating of the display or a frame buffer and/or to the format that the output frames are stored in the frame buffer.

In an embodiment, the way that output frames are provided to the display device or a frame buffer is controlled (e.g. by the display controller) on the basis of the output frame comparisons. In an embodiment the rate of providing output frames or parts thereof to the display device or frame buffer, and/or whether or not to provide particular output frames or parts thereof to the display device or frame buffer, is controlled (e.g. by the display controller) on the basis of the frame comparisons.

In another embodiment, the way that output frames are written to, and/or are read from, the frame buffer is controlled on the basis of the output frame comparisons. In an embodiment the rate of writing frames to and/or of reading frames from the frame buffer, and/or whether or not to write particular output frames or parts thereof to the frame buffer, and/or the format in which the frames are written to and/or read from the frame buffer, is controlled on the basis of the frame comparisons.

In one embodiment, the update or refresh rate of the display device (i.e. the rate at which frames are read from or written to the frame buffer and/or provided to the display device) is controlled on the basis of the comparisons of the output frames that are generated by the data processing system.

In an embodiment, if it is determined by the output frame comparisons that the output image or a part thereof is not changing or is not changing very rapidly (e.g., and in an embodiment, at less than a threshold rate), the display device or frame buffer update (refresh) rate (e.g. for that part) is reduced, and vice-versa. In this case, when it is determined that the output frames or parts thereof being generated for display are only changing at a low rate, the image or a part thereof that is displayed on the display device or stored in the frame buffer is updated at a lower rate, thereby reducing power consumption and bandwidth for the display or frame buffer operation.

In an embodiment, if it is determined by the output frame comparison that a new output frame or a part thereof should be considered to be the same as the current output frame or a corresponding part thereof being displayed or stored in the frame buffer, then the output display or frame buffer is not updated (e.g. for that part), but if it is determined by the output frame comparison that a new output frame or a part thereof should be considered to be different to the output frame or a corresponding part thereof currently being displayed or stored in the frame buffer, then the output display or frame buffer (e.g. for that part) is updated.

By controlling the rate that the display device or frame buffer is updated in this manner, unnecessary updates to the display device or frame buffer can be avoided or eliminated, thereby saving power and bandwidth in one or more of, e.g., the display device, the frame buffer memory, the interconnect, the display controller, etc.

For example, if one considers first order effects of frame buffer accesses only, and ignores on-chip interconnect, display controller, and video output power consumption, reducing the display refresh rate for an LCD display from 60 fps (frames per second) to 20 fps using the technology described herein may save 200 mW and 316 MB/s for HD and 75 mW and 120 MB/s for 1024×768 resolution displays.

It is believed that such arrangements may be new and advantageous in their own right.

Thus, according to another embodiment of the technology described herein comprises a method of operating a data processing system in which a stream of output frames to be displayed is generated by the data processing system for display on a display device, the method comprising:

the data processing system comparing output frames to be displayed, and controlling the rate at which the display device or a frame buffer or a part thereof is updated on the basis of the comparison.

Another embodiment of the technology described herein comprises a data processing system in which a stream of output frames to be displayed is generated by the data processing system for display on a display device, the system comprising:

a display device for displaying an output frame; and

processing circuitry for comparing output frames to be displayed and for controlling the rate at which the display device or a frame buffer or a part thereof is updated on the basis of the comparison.

Another embodiment of the technology described herein comprises a display control apparatus for use in a data processing system in which a stream of output frames to be displayed is generated by the data processing system for display on a display device, the apparatus comprising:

processing circuitry configured to compare output frames to be displayed, and to control the rate at which the display device or a frame buffer or a part thereof is updated on the basis of the comparison.

A display controller of the data processing system may compare the output frames to be displayed and control the rate at which the display device or a frame buffer or a part thereof is updated on the basis of the comparison (i.e. the above-mentioned processing circuitry may form part of the display controller).

Thus, another embodiment of the technology described herein comprises a method of operating a data processing system in which a stream of output frames to be displayed is generated by the data processing system for display on a display device, the method comprising:

a display controller of the data processing system comparing output frames to be displayed, and controlling the rate at which the display device or a frame buffer or a part thereof is updated on the basis of the comparison.

Another embodiment of the technology described herein comprises a data processing system in which a stream of output frames to be displayed is generated by the data processing system for display on a display device, the system comprising:

a display device for displaying an output frame; and

a display controller comprising processing circuitry for comparing output frames to be displayed and for controlling the rate at which the display device or a frame buffer or a part thereof is updated on the basis of the comparison.

Another embodiment of the technology described herein comprises a display controller for use in a data processing system in which a stream of output frames to be displayed is generated by the data processing system for display on a display device, the display controller comprising:

processing circuitry configured to compare output frames to be displayed, and to control the rate at which the display device or a frame buffer or a part thereof is updated on the basis of the comparison.

As discussed above, the technology described herein may comprise the display controller reading in, e.g. from a frame buffer, output frames generated by the data processing system for display and/or generating composited output frames to be displayed from plural input layers (frames) generated by the data processing system. The technology described herein may also comprise writing (e.g. composited) output frames generated by the data processing system (e.g. by the display controller) to be displayed to a frame buffer.

Thus, another embodiment of the technology described herein comprises a method of operating a data processing system in which a stream of output frames to be displayed is generated by the data processing system and written to a frame buffer for display on a display device, the method comprising:

the data processing system comparing output frames to be displayed, and controlling the rate at which the display device or a part thereof is updated from the frame buffer on the basis of the comparison.

According to another embodiment of the technology described herein comprises a data processing system comprising:

a data processor for generating a stream output frames to be displayed;

a frame buffer for storing an output frame to be displayed;

a write controller for writing an output frame generated by the data processor to the frame buffer;

a display device for displaying an output frame;

a display controller for reading an output frame from the frame buffer and for providing it to the display device for display; and

processing circuitry for comparing output frames to be displayed and for controlling the rate at which the display device or a part thereof is updated from the frame buffer on the basis of the comparison.

According to another embodiment of the technology described herein comprises a display control apparatus for use in a data processing system in which successive output frames to be displayed are generated by the data processing system and written to a frame buffer for display on a display device, the apparatus comprising:

processing circuitry configured to compare output frames to be displayed, and to control the rate at which the display device or a part thereof is updated from the frame buffer on the basis of the comparison.

As will be appreciated by those skilled in the art, these embodiments of the technology described herein may and in an embodiment do include any one or more or all of the features of the technology described herein described herein, as appropriate. Thus, for example, in an embodiment successive generated output frames are compared and if they are determined to be the same, the display device or frame buffer or a part thereof is not updated, and vice-versa.

In an arrangement of these embodiments of the technology described herein, the display operation is configured to always update the display device or frame buffer at a minimum rate (e.g. to always update the display or frame buffer after a predetermined time period since the last update), irrespective of the result of the frame comparisons. This will help to avoid the displayed image fading away or degrading too much as a consequence of the operation of the technology described herein (and the minimum rate is in an embodiment selected accordingly so as to achieve this).

Thus, in an embodiment, the display device or frame buffer or a part thereof is updated (e.g. the frame buffer is read out to the display device and/or an output frame or a part thereof is provided to the display device or frame buffer) only when the output frame or a part thereof has been determined to change, subject to an overall minimum update rate (that is chosen, e.g., to avoid flicker). This will keep the number of display device or frame buffer updates to a minimum whilst still ensuring a satisfactory displayed image.

A down counter may, for example, be used to trigger the “minimum rate” display updates.

It would also be possible to set a maximum update rate, if desired. This may be useful where, for example, the data processing system can produce output frames at a rate that is much higher than is needed for the display device. Again, a “maximum update rate” down counter could be used to prevent display updates at too high a rate.

In an embodiment of these arrangements of the technology described herein, the display device's backlight is also controlled to reduce the perception of flickering at lower update rates (by adjusting the backlight to keep the display brightness constant). For example where, as discussed below, only a portion of the displayed image is updated, the older portions of the image may have faded, whilst the recently updated portion of the image will be brighter. The backlight can be controlled to minimise the disparity between these different portions of the display. Where the backlight can be controlled independently for different portions of the display, the backlight may be controlled with finer granularity to achieve this, if desired.

Although in one embodiment it is the entire output frame or frame buffer that is updated (or not) on the display device on the basis of the output frame comparisons, if the display device supports the possibility of updating only part (but not all) of the displayed frame or frame buffer, then the present embodiment can equally be applied in respect of particular regions or parts of the output display or frame buffer only. Thus, in an embodiment, the frame comparisons assess whether a particular part or parts of the output frame have changed, and then those particular parts of the frame on the display device or stored in the frame buffer are updated (or not) accordingly. This would then facilitate only updating on the display device or in the frame buffer those parts or regions of the displayed frame that have changed, rather than having to update the whole displayed or stored frame.

In another embodiment, the way that the output frame is stored in the frame buffer (such as, and in an embodiment, the frame buffer format that is used) is controlled (selected) on the basis of the output frame comparisons. This may be instead of or in addition to varying the display device or frame buffer update rate on the basis of the output frame comparisons.

In an embodiment, the output frame is stored in a relatively higher or a relatively lower quality format on the basis of the output frame comparisons. In an embodiment a lower quality format is used where the output frame is determined to be changing a lot and/or relatively rapidly (as in this case a lower quality format may be acceptable), but a higher quality format is used when the output frames are not changing so much and/or are determined to be static (as this will provide a higher quality display whose quality may be visible on a relatively static or unchanging display, but not really appreciable where the display is changing more rapidly).

In these arrangements, the lower quality format may, e.g., be a lossy or more lossy format (e.g. have a higher compression ratio), whereas the higher quality format may be, e.g., a less lossy format (have a lower compression ratio) or lossless.

In one arrangement of these embodiments of the technology described herein, the lower quality format that is used is a YUV format or similar (which, as is known in the art, is a format that is often used for video where the image is constantly moving), such as YUV 4:2:0, and the higher quality format is an RGB format or similar, such as RGB 8:8:8 or RGB 10:10:10 (which is a much higher quality format than YUV 4:2:0 for example, but whose additional quality tends only really to be visible on static images such as when viewing a static computing desktop or user interface (UI)).

Other possible arrangements would be to use higher and lower frame buffer resolutions, higher and lower dynamic ranges (colour depth) for the frame buffer, and other more or less lossy compression schemes. In the case of rendering the image at a lower resolution (e.g. when the image is changing rapidly) the display controller or another system component may then scale the image to full size for display.

Another arrangement would be to perform partial frame updates of the frame in the frame buffer when a lower quality frame buffer is desired (acceptable). For example, the data processor could be configured to generate only a part of the new frame each time, such that, for example, for a first new frame only the top left portion of the frame is generated, followed a frame later by the bottom right portion of the frame and so on until the whole frame has been generated anew. Other suitable such schemes could generate appropriately only every other line (or column) of the frame when a new frame is generated. This will reduce the workload for generating the output frame in the first place, thereby reducing power consumption and data processor bandwidth.

For displays or frame buffers that support partial frame updates, portions of the frame only could be sent to the display or written out to a frame buffer (e.g. by the display controller), again reducing power consumption and bandwidth.

These arrangements of the technology described herein therefore effectively facilitate using a lower quality frame buffer format, thereby reducing power consumption and bandwidth, when there would be less or no perceived benefit to using a higher quality frame buffer format (e.g. because the output display is changing rapidly such that the user will be unable to perceive a great deal of detail in the displayed image in any event), but reverting to a higher quality image format (such as RGB) when the additional quality of the image will actually be appreciated by the viewer (e.g. because the image is static).

Thus, by selectively and dynamically switching between different frame buffer formats based on the comparisons of the output frames, a system that has, for example, improved quality as compared to a system that always uses a YUV format frame buffer, but that reduces memory bandwidth and power consumption as compared to a system that always uses an RGB format frame buffer, can be provided.

It is again believed that these arrangements may be new and advantageous in their own right.

Thus, according to another embodiment of the technology described herein comprises a method of operating a data processing system in which a stream of output frames to be displayed is generated by the data processing system and written to a frame buffer for display on a display device, the method comprising:

the data processing system comparing output frames to be displayed, and selecting the way in which the output frames are stored in the frame buffer on the basis of the comparison.

According to another embodiment of the technology described herein comprises a data processing system comprising:

a data processor for generating a stream of output frames to be displayed;

a frame buffer for storing an output frame to be displayed;

a write controller for writing an output frame generated by the data processor to the frame buffer;

a display device for displaying an output frame;

a display controller for reading an output frame from the frame buffer and for providing it to the display device for display; and

processing circuitry for comparing output frames to be displayed and for selecting the way in which the output frames are stored in the frame buffer on the basis of the comparison.

According to another embodiment of the technology described herein comprises a display control apparatus for use in a data processing system in which successive output frames to be displayed are generated by the data processing system and written to a frame buffer for display on a display device, the apparatus comprising:

processing circuitry configured to compare output frames to be displayed, and to select the way in which the output frames are stored in the frame buffer on the basis of the comparison.

As will be appreciated by those skilled in the art, these embodiments of the technology described herein may and in an embodiment do include any one or more or all of the features of the technology described herein described herein, as appropriate. Thus, for example, the format to be used when storing the output frames in the frame buffer is in an embodiment selected on the basis of the frame comparisons, and the system in an embodiment selects between a lower quality frame buffer format, such as YUV, and a higher quality format such as RGB.

In an arrangement of these embodiments of the technology described herein, when the output frame comparisons indicate that the output frame is changing at greater than a particular, in an embodiment predetermined rate, the output frames are in an embodiment stored in the frame buffer in a lower quality fashion, e.g., in a lower quality format, but when the rate of changing of the output frames drops (is lower) (e.g. and in an embodiment changes at less than a particular, in an embodiment predetermined rate (which may be same or a different rate to threshold rate for using a lower quality frame buffer format)) and/or the image becomes static, the output frames are stored in the frame buffer in a higher quality fashion, e.g., format (and vice-versa).

In these embodiments of the technology described herein, the data processing system and/or data processor could be controlled to generate its output frames in the desired frame buffer format (or other fashion) in the first place (for storage then in the frame buffer in that desired (appropriate) format or fashion).

Alternatively, there could be some form of format conversion or processing stage or element (circuitry) that converts the output frames, if necessary, to the desired frame buffer format, etc., before they are stored in the frame buffer. (For example, the output frame could be generated in one format by the data processor but then converted to the desired frame buffer format before it is stored in the frame buffer).

In these arrangements, the stored output frame in an embodiment has associated with it (e.g. stored with it or in association with it) control information to allow the stored frame in the frame buffer to be provided in the appropriate format to the display device (where that is necessary). This control information may, e.g., indicate what format the frame has been stored in the frame buffer, and/or may indicate, or comprise, an algorithm for converting the data in the frame buffer to the desired final display format.

Then, when the frame is read from the frame buffer for display, this control information is in an embodiment also read (e.g. by the display controller) to allow the frame buffer format and/or necessary conversion process to be determined so that the stored frame can be converted appropriately (and if necessary) to the desired format for the display device.

Again, although in one arrangement of these embodiments of the technology described herein it is the entire output frame that is stored in the desired frame buffer format, etc., it would equally be possible, as for the display updating, to apply these techniques in respect of particular portions or regions of the (stored) output frame only. Thus, for example, different frame buffer formats could be used for different portions of a frame (and in one embodiment this is done), e.g., depending upon the determined rate of change of the respective portions of the frame.

Thus, in an embodiment, the frame comparisons assess whether a particular part or parts of the output frame have changed, and then the way in which those particular parts of the frame are stored in the frame buffer (such as the frame buffer format to be used) is selected accordingly. This would then facilitate varying the frame buffer format, for example, for those parts or regions of the displayed frame that have changed, without having to change the format for the whole frame buffer.

Other aspects of the writing and reading of the output frames to and from the frame buffer could also or instead be controlled on the basis of the comparison of the output frames generated by the data processing system, if and as desired.

For example, the level of anti-aliasing (e.g. of multisampling or supersampling) being used could be varied based on the output frame comparisons, e.g. to use better anti-aliasing (thereby giving higher (perceived) image quality) when it is determined that the image is only changing slowly and/or is static and vice-versa.

It would also or instead be possible to vary the rate at which the output frames are produced by the data processing system based on the output frame comparisons, for example, to reduce the rate of output frame generation (thereby reducing power consumption) when it is determined that the image is only changing slowly and/or is static and vice-versa.

The output frames that are generated by the data processing system can be compared in any suitable and desired manner. As discussed above, the comparison is in an embodiment so as to determine or at least estimate whether the frames or corresponding parts thereof are changing or have changed, and/or the rate at which the frames or corresponding parts thereof are changing. Any comparison process that is able to assess this may be used.

Thus, in an embodiment, the comparison process is so as to assess or estimate (and is to be used to assess or estimate) the correlation between successive, and/or sequences of, output frames or corresponding parts thereof generated by the data processing system (i.e. the extent to which the output frames or corresponding parts thereof are similar to each other). Thus, the comparison is in an embodiment so as to determine whether one frame or a part thereof is the same as (or at least sufficiently similar to) the other (or another) frame or a corresponding part thereof or not.

Then, if the comparison process indicates that successive frames or corresponding parts thereof are the same (the correlation is high) that would suggest, e.g., that the image or that part of the image is static for a period of time (in which case, as discussed above, it may be possible to reduce the display or frame buffer update rate (e.g. for that part), for example), and vice-versa.

In an embodiment the comparison process uses some form of threshold or tide value or values (parameter or parameters) to determine whether the output frames or corresponding parts thereof should be considered to be changing or not (to be different or to be static) for the purposes of the control operation of the technology described herein. Then, if the comparison indicates a value to one or other side of the appropriate threshold, the display or frame buffer operation will be controlled accordingly.

In an embodiment, the comparison process compares one output frame or a part thereof with its immediately preceding output frame or a corresponding part thereof (i.e. such that adjacent frames or corresponding parts thereof in the stream of output frames generated by the data processing system are compared with each other). This is in an embodiment done by comparing a newly generated output frame or a part thereof with the (appropriate) previous output frame or corresponding part thereof, e.g. an output frame or corresponding part thereof that is currently being displayed or currently stored in the frame buffer.

Thus, in an embodiment a newly generated output frame or a part thereof is compared with a previous output frame or corresponding part thereof, e.g. an output frame or corresponding part thereof already stored in the frame buffer, in an embodiment so as to determine whether the new output frame or part thereof should be considered to be the same as (or at least sufficiently similar to) the previous output frame or corresponding part thereof, e.g. the output frame or corresponding part thereof already being displayed or stored, or not.

The comparison is in an embodiment repeated for each new output frame or part thereof that is generated, i.e. such that there will be successive comparisons of pairs of output frames or corresponding parts thereof as the output frames are generated by the data processing system.

In this case, the system could, e.g., count how many compared frames or corresponding parts thereof are considered to be the same as each other (or to differ from each other), e.g. in a given period and then compare that count to a threshold value to determine whether the image should be considered to be static (unchanging) or not.

In an embodiment, the comparison process determines whether a respective pair of frames or corresponding parts thereof being compared should be considered to be the same as each other or not, and the display or frame buffer control is then performed on the basis of that assessment, e.g., to update the display device or a frame buffer if the frames are considered to be different or partially update the display device or a frame buffer if the corresponding parts of the frames are considered to be different but not otherwise, and so on. This will then provide a dynamic and “instant” response to the output frames that are being produced.

Other arrangements would, of course, be possible. For example, a series of more than two output frames or corresponding parts thereof could be compared with each other if desired.

The comparison process in an embodiment compares some or all of the content of each output frame or parts thereof that is being compared.

In an embodiment, the comparison is performed by comparing information, e.g. a “signature”, representative of and/or derived from the content of one output frame or a part thereof with information, e.g. a “signature”, representative of and/or derived from the other output frame or a corresponding part thereof, e.g., and in an embodiment, to assess the similarity or otherwise of the output frames or corresponding parts thereof.

The Applicants have recognised that in many data processing system arrangements, an output frame will be processed on a region by region basis, rather than as a single, overall, output “frame”.

For example, the Applicants have recognised that in many data processing system arrangements, an output frame will be provided to the display device (e.g. by the display controller) on a line by line basis, rather than directly as a single, overall, output “frame”. As will be appreciated, for an output frame having two dimensions, a “line” can relate to or comprise a region of the output frame that is, for example, one display position (e.g. pixel) wide in one dimension (e.g. the vertical dimension) and plural display positions (e.g. pixels) wide in the other dimension (e.g. the horizontal dimension).

Where the technology described herein is implemented in a data processing system in which the overall, “final” output frame of the data processing system is provided to the display device (e.g. by the display controller) on a line by line basis, then in an embodiment the output frames are compared (e.g. by the display controller) by comparing respective line portions or groups of line portions (“line portion groups”) of the output frames. In other words, the comparison process in an embodiment comprises (e.g. the display controller) comparing line portions or groups of line portions of the respective output frames with each other. A group of line portions may comprise, for example, plural line portions from respective lines. In an embodiment of these arrangements of the technology described herein, the line portions or groups of line portions are compared (e.g. by the display controller) by comparing a line portion or group of line portions that is newly generated by the data processing system (for a new output frame) with at least one line portion or group of line portions of a previous output frame.

Thus, in an embodiment of the technology described herein, the data processing system comprises a data processing system in which the output frame is provided to the display device (e.g. by the display controller) by providing lines of data representing the output frame to the display device, and the comparison process comprises comparing a line portion or group of line portions that is to be provided to the display device (e.g. by the display controller) to at least one line portion or group of line portions already provided to the display device (e.g. by the display controller). This will then in an embodiment be repeated for plural line portions or groups of line portions making up the respective output frame being provided (e.g. by the display controller).

In embodiments in which line portions or groups of line portions are considered and compared (e.g. by the display controller), the line portions can each represent any suitable and desired portion of an output frame that is to be provided to the display device (e.g. by the display controller). So long as the output frame is divided or partitioned into a plurality of identifiable smaller line portions or groups of line portions, with each line portion representing all or part of a line, that can be identified and compared (e.g. by the display controller), then the sub-division of the output frame into line portions or groups of line portions can be done as desired. Each line portion or group of line portions in an embodiment represents a different part of the output frame (although the line portions or groups of line portions could overlap if desired). The output frame may be divided into regularly sized and shaped line portions or groups of line portions. However, this is not essential and other arrangements could be used if desired. Suitable line portion sizes would be, e.g., all, ½, ¼, ⅛, etc., of a line. Suitable sizes for groups of line portions would be, e.g. 2, 4, 8 etc. line portions. A group of line portions may comprise plural (e.g. vertically) adjacent and/or similarly sized line portions from respective (e.g. horizontal) lines. For example, a group of line portions may comprise 2 vertically adjacent line portions that are both ½ of a horizontal line.

The Applicants have also recognised that in many data processing system arrangements, an output frame for display will be generated and stored in the frame buffer on a data-block-by-data-block basis, rather than directly as a single, overall, output “frame”. As will be appreciated, for an output frame having two dimensions, a “block” can relate to or comprise a region of the output frame that is, for example, plural display positions (e.g. pixels) wide in both dimensions (e.g. the vertical and horizontal dimensions).

This will be the case, for example, and as will be appreciated by those skilled in the art, in a tile-based graphics processing system, in which case each block of data that is generated and stored in the frame buffer may correspond to a “tile” that the rendering process of the graphics processor produces.

(As is known in the art, in tile-based rendering, the two dimensional output array or frame of the rendering process (the “render target”) (e.g., and typically, that will be displayed to display the scene being rendered) is sub-divided or partitioned into a plurality of smaller regions, usually referred to as “tiles”, for the rendering process. The tiles (sub-regions) are each rendered separately (typically one after another). The rendered tiles (sub-regions) are then recombined to provide the complete output array (frame) (render target), e.g. for display.

Other terms that are commonly used for “tiling” and “tile based” rendering include “chunking” (the sub-regions are referred to as “chunks”) and “bucket” rendering. The terms “tile” and “tiling” will be used herein for convenience, but it should be understood that these terms are intended to encompass all alternative and equivalent terms and techniques.)

Where the technology described herein is implemented in a data processing system in which the overall, “final” output frame of the data processing system is stored in the frame buffer on a block-by-block basis, then in an embodiment the output frames are compared by comparing respective data blocks of the output frames. In other words, the comparison process in an embodiment comprises comparing blocks of data representing particular regions of the respective output frames with each other.

In an embodiment of these arrangements of the technology described herein, the data blocks are compared by comparing a data block that is newly generated by the data processing system (for a new output frame) with at least one data block of a previous output frame, e.g., and in an embodiment, that is already stored in the frame buffer.

Thus, in an embodiment of the technology described herein, the data processing system comprises a data processing system in which the output frame is stored in the frame buffer by writing blocks of data representing particular regions of the output frame to the frame buffer, and the comparison process comprises comparing a block of data that is to be written to the frame buffer to at least one block of data already stored in the frame buffer. This will then in an embodiment be repeated for plural data blocks making up the respective output frame being generated.

The blocks of data that are considered and compared in these embodiments of the technology described herein can each represent any suitable and desired region (area) of the overall output frame that is to be stored in the frame buffer. So long as the overall output frame is divided or partitioned into a plurality of identifiable smaller regions each representing a part of the overall output frame, and that can accordingly be represented as blocks of data that can be identified and compared, then the sub-division of the output frame into blocks of data can be done as desired.

Each block of data in an embodiment represents a different part (sub-region) of the overall output frame (although the blocks could overlap if desired). Each block should represent an appropriate portion (area) of the output frame, such as a plurality of data positions within the frame. Suitable data block sizes would be, e.g., 8×8, 16×16 or 32×32 data positions in the output frame.

In one embodiment, the output frame is divided into regularly sized and shaped regions (blocks of data), in an embodiment in the form of squares or rectangles. However, this is not essential and other arrangements could be used if desired.

Where the data processor is a tile-based graphics processor, then in an embodiment, each data block that is compared corresponds to a rendered tile that the graphics processor produces as its rendering output. This is a particularly straightforward way of implementing these arrangements of the technology described herein, as the graphics processor will generate the rendering tiles directly, and so there will be no need for any further processing to “produce” the data blocks that will be considered and compared. In this case therefore, as each rendered tile generated by the graphics processor is to be written to the frame buffer, it will in an embodiment be compared with a rendered tile or tiles already stored in the frame buffer.

In these arrangements of the technology described herein, the (rendering) tiles that the output frame is divided into for rendering purposes can be any desired and suitable size or shape. The rendered tiles are in an embodiment all the same size and shape, as is known in the art, although this is not essential. In an embodiment, each rendered tile is rectangular, and in an embodiment 16×16, 32×32 or 8×8 sampling positions in size.

In an embodiment of these arrangements of the technology described herein, the comparison may be, and in an embodiment is, also or instead performed using data blocks of a different size and/or shape to the tiles that the rendering process operates on (produces).

For example, in an embodiment, a or each data block that is considered and compared may be made up of a set of plural “rendered” tiles, and/or may comprise only a sub-portion of a rendered tile. In these cases there may be an intermediate stage that, in effect, “generates” the desired data block from the rendered tile or tiles that the graphics processor generates.

In one embodiment, the same line portion, line portion group or block (region) configuration (size and shape) is used across the entire output frame. However, in another embodiment, different line portion, line portion group or block configurations (e.g. in terms of their size and/or shape) are used for different regions of a given output frame. Thus, in one embodiment, different line portion, line portion group or data block sizes may be used for different regions of the same output frame.

Where the comparison process involves comparing respective line portions, line portion groups or blocks of data, then the comparison is, similarly, in an embodiment so as to determine whether the new line portion, line portion group or data block is the same as (or at least sufficiently similar to) the already provided or stored line portion, line portion group or data block or not, and in an embodiment comprises comparing some or all of the content of the new line portion, line portion group or data block with some or all of the content of the already provided or stored line portion, line portion group or data block.

In an embodiment, the comparison is performed by comparing information representative of and/or derived from the content of the new line portion, line portion group or data block with information representative of and/or derived from the content of the already provided or stored line portion, line portion group or data block. In such a case, the information representative of the content of each line portion, line portion group or data block is in an embodiment in the form of a “signature” for the line portion, line portion group or data block which is generated from or based on the content of the line portion, line portion group or data block. (Such a line portion, line portion group or data block content “signature” may comprise, e.g., and in an embodiment, any suitable set of derived information that can be considered to be representative of the content of the line portion, line portion group or data block, such as a checksum, a CRC, or a hash value, etc., derived from (generated for) the line portion, line portion group or data block. Suitable signatures would include standard CRCs, such as CRC32, or other forms of signature such as MD5, SHA-1, etc.)

Thus, in an arrangement of these embodiments of the technology described herein, a signature, such as a CRC value, is generated for each line portion, line portion group or data block, e.g. that is to be provided or that is to be written to the frame buffer (e.g. and in an embodiment, for each output rendered tile that is generated), and the comparison process comprises comparing the signatures of the respective line portions, line portion groups or data blocks.

The signatures for the line portions, line portion groups or data blocks (e.g. rendered tiles) that are provided or that are stored in the frame buffer should be stored appropriately. In an embodiment they are stored in a buffer, e.g. with the frame buffer. Then, when the signatures need to be compared, the stored signature for a line portion, line portion group or data block can be retrieved appropriately. The signatures may, for example, be stored or cached in (e.g. a buffer or cache of) the data processor that generates the output frame. These embodiments may be particularly useful, for example, in embodiments in which there are relatively fewer regions or signatures to be considered. The signatures may also or instead be stored externally to the data processor that generates the output frame (e.g. in (main) memory of the data processing system). These embodiments may be particularly useful, for example, in embodiments in which there are relatively more regions or signatures to be considered.

The current, completed (newly generated) line portion, line portion group or data block (e.g. rendered tile) (e.g., and in an embodiment, its signature) can be compared with one, or with more than one, line portion, line portion group or data block that is already provided or that is already stored in the frame buffer. It should be compared with the equivalent line portion, line portion group or data block (or line portions, line portion groups or blocks, if appropriate) already provided or stored in the frame buffer (i.e. the line portion, line portion group or data block(s) on the display or in the frame buffer occupying the same position (the same line portion, line portion group or data block (e.g. tile) position)) as the completed, new line portion, line portion group or data block is to be provided for or is to be written to).

In one embodiment, all the line portions, line portion groups or data blocks making up the output frame being considered are compared. However, in other arrangements some but not all of the line portions, line portion groups or blocks are compared. This could be the case where, for example, only a portion of the output frame is to be considered, or where, for example, it is known that a certain portion of the frame is always going to change or be static (such that that portion doesn't need checking). In the latter case, information about whether portions of the image are static or dynamic could, e.g., be provided to the comparison processing circuitry, for example by the application in question.

The former case could occur, for example, where, as discussed above, the display arrangement supports updating only part but not all of the displayed frame or frame buffer or, for composited output frames, where an output frame does not contribute to (e.g. a particular region of) the composited output frame. In this case the comparisons could be carried out in respect of particular regions of the output frame only, i.e. for those parts of the frame that are being, or that are potentially to be, updated.

In an embodiment, the number of line portions, line portion groups or data blocks that are compared with an already provided or stored line portion or portions, line portion group or groups, or data block or blocks for respective output frames is varied, e.g., and in an embodiment, on a frame-by-frame, or over sequences of frames, basis. This may be particularly applicable where, for example, only portions of the display are to be updated or different regions are to be stored in different formats. It is in an embodiment based on the expected correlation (or not) between successive output frames.

In an embodiment, it is possible for the software application that is controlling the display to indicate and control which regions of the frame are compared, e.g., in particular, and in an embodiment, to indicate which regions of the frame the data comparison process should be performed for. This would then allow the comparison calculation to be “turned off” by the application for regions of the frame the application “knows” will be static.

This may be achieved as desired. In an embodiment registers are provided that enable/disable line portion, line portion group or data block (e.g. rendered tile) signature comparison for frame regions, and the software application then sets the registers accordingly (e.g. via the graphics processor driver). The number of such registers may be chosen, e.g., as a trade-off between the extra logic required for the registers, the desired granularity of control, and the potential savings from being able to disable the comparison calculations.

It would also be possible to use information in registers elsewhere in the system, for example in a graphics processor's scissor or stencil registers, to determine where comparisons need to be made, if desired.

The line portion, line portion group or data block comparisons are in an embodiment used, as discussed above, to estimate or determine the similarity or not of (the correlation between) the output frames or parts thereof being compared. This may be estimated on the basis of the number of line portions, line portion groups or data blocks that are found to match (that are considered to match) and/or that are found to mis-match between the two frames. The number of mismatching (unmatching) line portions, line portion groups or data blocks in the frames being compared may be counted and if the number of mis-matching blocks exceeds a particular, e.g. predetermined, threshold value, the two frames or parts thereof are considered not to match (i.e. the image or a part thereof is considered to have changed), and vice-versa (as between those two output frames).

Thus, in an embodiment, the number of line portions, line portion groups or data blocks found to match or to mismatch in the two output frames or parts thereof being compared is used as a measure of the correlation of the frames or parts thereof and to determine how the relevant aspect of the display operation should be controlled. For example, and in an embodiment, if the count of mismatching line portions, line portion groups or blocks exceeds a threshold value, the display or a part thereof is updated, but not otherwise. Similarly, if the count of mismatching blocks is above a threshold value (which would in an embodiment be a higher value than the threshold to trigger a display update), then in an embodiment a lower quality (less accurate) frame buffer format is used.

The count of mismatching (or matching) line portions, line portion groups or data blocks may be performed as desired, for example by using a standard counter, using a bitmap that can be analysed, or using a hierarchical count (e.g. a count per tile, then a level up of a count for a group of four tiles, and so on, all the way up to a single count per frame). A hierarchical count would allow portions of the frame that have matches or mismatches to be searched rapidly.

In one embodiment, where the number of matching line portions, line portion groups or blocks is below a threshold value, the mismatching line portions, line portion groups or blocks are analysed to determine the magnitude of the visual differences, and the display operation is controlled on the basis of the determined magnitude of the visual differences.

The technology described herein may comprise buffering the newly generated output frame and/or a part thereof (e.g. one or more line portions or blocks), e.g. in the frame buffer and/or in a display position (e.g. pixel) buffer (e.g. of the display controller). The technology described herein may then comprise either outputting or not outputting the buffered output frame or part thereof for display on the basis of the comparison of the output frames.

In these embodiments, the comparison process of the technology described herein may compare the current (newly generated) output frame or a part thereof stored in the buffer with the output frame or a corresponding part thereof that is currently being displayed. The current output frame or part thereof may be buffered to the extent necessary (e.g., and only to the extent necessary) to decide whether or not to provide that output frame or part thereof to the display device or frame buffer. These embodiments can reduce the size of the buffer required for the buffering.

Where the technology described herein is to be used with a double-buffered frame buffer, i.e. a frame buffer which stores two output frames concurrently, e.g. one being displayed and one that has been displayed and is therefore being written to as the next output frame to display, then the comparison process of the technology described herein in an embodiment compares the newly generated output frame or part thereof with the output frame or corresponding part thereof in the frame buffer that is currently being displayed.

The comparison process and consequent display control may be implemented in an integral part of the data processor(s) that generate the stream of output frames to be displayed, or there may, e.g., be a separate hardware element or elements that perform these functions. The data processor(s) that generate the stream of output frames to be displayed may comprise, e.g., a central processor, a graphics processor, a video processor, a display controller, etc.

In an embodiment, there is a “display control” hardware element or elements that carry out the comparison process and control the relevant display operation.

In one embodiment, this hardware element or elements is separate to the data processor(s) that generate the stream of output frames to be displayed, and in another embodiment is integrated in (part of) one or more data processor(s) that generate the stream of output frames to be displayed. Thus, in one embodiment, the comparison element etc., is part of the data processor(s) that generate the stream of output frames to be displayed themselves, but in another embodiment, the data processing system comprises a data processor or processors that generate the stream of output frames to be displayed, and a separate “display control” unit or units or element or elements (e.g. of or for a different processor) that perform the frame comparison, etc.

Thus, the display control hardware element or elements that perform the frame comparison, etc. may form part of a data processor that generates a stream of output frames to be displayed. For example, in one embodiment, the data processor that generates the stream of output frames to be displayed and that comprises the display control hardware element or elements that perform the frame comparison, etc. is a central processor, graphics processor, a video processor, a display controller, etc.

However, the display control hardware element or elements that perform the frame comparison, etc. may not form part of the data processor(s) that generate the stream of output frames to be displayed. For example, in one embodiment, the data processor(s) that generate the stream of output frames to be displayed may be a central processor, a graphics processor and/or a video processor and the data processor that comprises the display control hardware element or elements that perform the frame comparison, etc. is a display controller.

The technology described herein can be used wherever a data processing system is providing output frames intended to form an image for display.

Similarly, although in one embodiment the technology described herein is used in conjunction with a graphics processing system (and the data processor is a graphics processor), the principles of the technology described herein can equally be applied to other systems that will produce output frames for display in a similar manner to graphics processing systems. Thus the technology described herein may equally be used, for example, for video processing (and video processing analogously operates on blocks of data analogous to the tiles in tile-based graphics processing (in which case the data processor will be a video processor)), and for composited image processing (the composition frame buffer can be processed as distinct blocks or line portions of data).

In such arrangements, in a similar manner to that discussed above the line portions, line portion groups or data blocks that are compared (where that is done) may comprise, e.g., video data blocks produced by the video processing system (a video processor), and/or composited frame line portions, composited line portion groups or composited frame tiles produced by a composition processing system (e.g. a display controller), etc.

In such arrangements, the composition processing system (e.g. the display controller) may generate composited output frames from plural input layers (frames). The composition processing system (e.g. the display controller) may comprise processing circuitry (e.g. a composition unit) that is configured to generate the composited output frames from the plural input layers. The composition processing system (e.g. the display controller) may comprise plural buffers (e.g. latency buffers) that are configured to store the respective input layers prior to compositing.

As discussed above, the plural input layers may be generated by one or more data processors (e.g. a central processor, graphics processor and/or a video processor). The input layers may have associated with them one or more of: a display order (i.e. a front to back, or vice versa, order) in the composited output frame; positions relative to one another in the composited output frame; and one or more transparencies for (e.g. respective regions (e.g. blocks) of) the input layers.

In these embodiments in which composited output frames are generated from plural input layers, the comparison process may comprise (e.g. the display controller) comparing the composited output frames or parts thereof (e.g. by considering the information or “signature” representative of the content of that composited output frame or part thereof once generated from the plural layers), and controlling at least one aspect of the way in which the composited output frames or parts thereof are provided for display on the display device on the basis of the comparison of the composited output frames or parts thereof.

The comparison process may comprise (e.g. the display controller) considering whether the current composited output frame or part thereof is different to a previous composited output frame or part thereof. These embodiments are considered to be particularly advantageous since considering the composited output frame or part thereof (e.g. rather than the respective input layers or parts thereof) can reduce the number of comparisons that need to be performed and can be relatively more simple to implement.

In these embodiments, the information or “signatures” representative of the content of that composited output frame or part thereof once generated from the plural input layers may be generated and/or stored by the data processor (e.g. display controller) that generates the composited output frame from the plural input layers, e.g. once the relevant composited data has been generated. As discussed above, information or “signatures” may, for example, be stored or cached in (e.g. a buffer or cache of) the data processor (e.g. display controller) that generates the composited output frame from the plural input layers. These embodiments may be particularly useful, for example, in embodiments in which there are relatively fewer regions or signatures to be considered. The information or “signatures” may also or instead be stored externally to the data processor (e.g. display controller) that generates the composited output frame from the plural input layers (e.g. in (main) memory of the data processing system). These embodiments may be particularly useful, for example, in embodiments in which there are relatively more regions or signatures to be considered.

Alternatively, in embodiments in which composited output frames are generated from plural input layers, the comparison process may comprise (e.g. the display controller) comparing input layers or parts thereof that form the composited output frames (e.g. by considering the information or “signatures” representative of the content of the respective input layers or parts thereof), and controlling at least one aspect of the way in which the composited output frames or parts thereof are provided for display on the display device on the basis of the comparison of those input layers or parts thereof.

The comparison process may comprise (e.g. the display controller) considering whether a current input layer or part thereof for the current composited output frame to be generated is different to a corresponding previous input layer or part thereof for a previous composited output frame.

The comparison process may, for example, comprise (e.g. the display controller) considering (only) input layers (or regions (e.g. lines portions, line portion groups, or blocks) of input layers) that will contribute to (e.g. be visible in) a (e.g. particular (corresponding) region of the) current composited output frame to be displayed. The input layers (or regions) that will contribute to the (e.g. particular (corresponding) region of the) composited output frame may be determined (e.g. by the display controller) based on one or more of: the display order (i.e. the front to back, or vice versa, order) of the input layers in the composited output frame; the relative positions of input layers in the composited output frame; and one or more transparencies for (e.g. respective regions of) the input layers.

In these embodiments, the information or “signatures” representative of the content of the respective layers or parts thereof may be generated and/or stored by the data processor (e.g. display controller) that is to generate the composited output frame from the plural input layers or by the data processor(s) (e.g. central processor, graphics processor and/or video processor) that generated the respective input layers. Again, the information or “signatures” may, for example, be stored or cached in (e.g. a buffer or cache of) the data processor (e.g. display controller) that is to generate the composited output frame from the plural input layers. These embodiments may be particularly useful, for example, in embodiments in which there are relatively fewer regions or signatures to be considered. The information or “signatures” may also or instead be stored externally to the data processor (e.g. display controller) that is to generate the composited output frame from the plural input layers (e.g. in (main) memory of the data processing system). These embodiments may be particularly useful, for example, in embodiments in which there are relatively more regions or signatures to be considered.

The technology described herein also extends to the provision of a particular hardware element for performing the comparison and consequent display control determination of the technology described herein. As discussed above, this hardware element (logic) may, for example, be provided (at least in part) as an integral part of a, e.g., central processor, graphics processor, video processor, display controller or other processor, or may be a standalone element. It may be a programmable or dedicated hardware element.

Similarly, the buffer, e.g. frame buffer or display position (pixel) buffer, that the output frames or parts thereof are to be buffered in (written to) may comprise any suitable such buffer and may be configured in any suitable and desired manner in memory. For example, it may be an on-chip buffer or it may be an external buffer (and, indeed, in some embodiments may be more likely to be an external buffer (memory), as will be discussed below). Similarly, it may be dedicated memory for this purpose or it may be part of a memory that is used for other data as well.

The display device may similarly be any suitable form of display. In one embodiment it is an LCD display, although other display technologies could be used. The display device may comprise a display panel, an integral display frame buffer for the display device itself and/or an integral controller for the display device itself.

The updating of the display device may comprise (e.g. the display controller) providing appropriate frame data signalling. In addition to the output frame data itself, the frame data signalling may comprise one or more of: a horizontal synchronisation signal, a vertical synchronisation signal, and a frame data enable signal.

As discussed above, the display device or a frame buffer may support partial updates.

The partial updating of the display device (where that is done) may comprise (e.g. the display controller) providing appropriate partial update control signalling. The partial update control signalling may comprise one or more of: a partial update enable signal, a partial update area row start address, a partial update area update row end address, a partial update area column start address, and a partial update area column end address.

As will be appreciated, controlling the way in which the output frames are provided for display on the display device in the manner described herein can significantly reduce the amount of output frame data required to display output frames, thereby reducing overall power and bandwidth consumption and/or increasing the overall performance of the data processing system. Furthermore, using the display controller to control the way in which the output frames are provided for display on the display device can provide these advantages for a variety of sources of frame data (and not, e.g., only for specific sources of frame data).

The data processing system may further comprise a display device interface configured to provide a stream of output frame data (e.g. from the display controller) to the display device. The (e.g. display device interface of the) data processing system may comprise a (e.g. VESA) display stream compressor configured to compress a stream of output frame data being provided (e.g. by the display controller).

As will be appreciated, controlling the way in which the output frames are provided for display on the display device in the manner described herein (e.g. using the display controller) can also significantly reduce the amount of display stream compression required to display output frames, thereby further reducing overall power and bandwidth consumption and/or increasing the overall performance of the data processing system in these embodiments.

The (e.g. display device interface of the) data processing system may further comprise a physical layer (PHY) controller configured to provide a (e.g. compressed) stream of output frame data to the display device. The physical layer (PHY) controller may comprise a wired or wireless (e.g. WiFi.) physical layer (PHY) controller.

The partial updating of a frame buffer (where that is done) may comprise (e.g. the display controller) writing out appropriate parts of an (e.g. composited) output frame to the frame buffer and overwriting appropriate corresponding parts of an (e.g. composited) output frame already stored in the frame buffer. Thus, (e.g. the display controller) of the data processing system may be configured to write out part of an (e.g. composited) output frame to a frame buffer and overwrite a corresponding part of an (e.g. composited) output frame already stored in the frame buffer.

The contents of the partially updated (e.g. composited) frame buffer can then be read in (e.g. by the display controller) for display and/or read in (e.g. by a video processor) for encoding, e.g. prior to being output for display either on the display device or another display device. Thus, (e.g. the display controller of) the data processing system may be configured to read in a partially updated (e.g. composited) output frame from a frame buffer. Similarly, the data processing system may comprise a video processor configured to read in a partially updated (e.g. composited) output frame from a frame buffer and encode the partially updated output frame. The video processor may be configured to output the encoded partially updated (e.g. composited) output frame, e.g. for display on the display device or another display device.

The various functions of the technology described herein can be carried out in any desired and suitable manner. For example, the functions of the technology described herein can be implemented in hardware or software, as desired. Thus, for example, the various units and elements, etc., of the technology described herein may comprise a suitable processor or processors, functional units, circuitry, processing circuitry, logic, processing logic, microprocessor arrangements, etc., that are operable to perform the various functions, etc., such as appropriately dedicated hardware elements and/or programmable hardware elements that can be programmed to operate in the desired manner.

In an embodiment the data graphics, e.g., processor and/or display control unit or units is implemented as a hardware element or elements (e.g. ASIC). Thus, in another embodiment the technology described herein comprises a hardware element including the apparatus of, or operated in accordance with the method of, any one or more of the embodiments of the technology described herein described herein.

It should also be noted here that, as will be appreciated by those skilled in the art, the various functions, etc., of the technology described herein may be duplicated and/or carried out in parallel on a given processor.

The technology described herein is applicable to any suitable form or configuration of graphics processor and renderer, such as processors having a “pipelined” rendering arrangement (in which case the renderer will be in the form of a rendering pipeline). It is particularly applicable to tile-based graphics processors and graphics processing systems.

As will be appreciated from the above, the technology described herein is particularly, although not exclusively, applicable to 2D and 3D graphics processors and processing devices, and accordingly extends to a 2D and/or 3D graphics processor and a 2D and/or 3D graphics processing platform including the apparatus of, or operated in accordance with the method of, any one or more of the embodiments of the technology described herein described herein. Subject to any hardware necessary to carry out the specific functions discussed above, such a 2D and/or 3D graphics processor can otherwise include any one or more or all of the usual functional units, etc., that 2D and/or 3D graphics processors include. It will also be appreciated by those skilled in the art that all of the described embodiments of the technology described herein can include, as appropriate, any one or more or all of the features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program comprising computer software code for performing the methods herein described when the program is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or microprocessor system comprising a data processor causes in conjunction with said data processor, said processor, renderer or system to carry out the steps of the methods of the technology described herein. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible medium, such as a computer readable medium, for example, diskette, CD ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre loaded with a computer system, for example, on a system ROM or fixed disk, or distributed from a server or electronic bulletin board over a network, for example, the Internet or World Wide Web.

A number of embodiments of the technology described herein will now be described by way of example only and with reference to the accompanying drawings, in which:

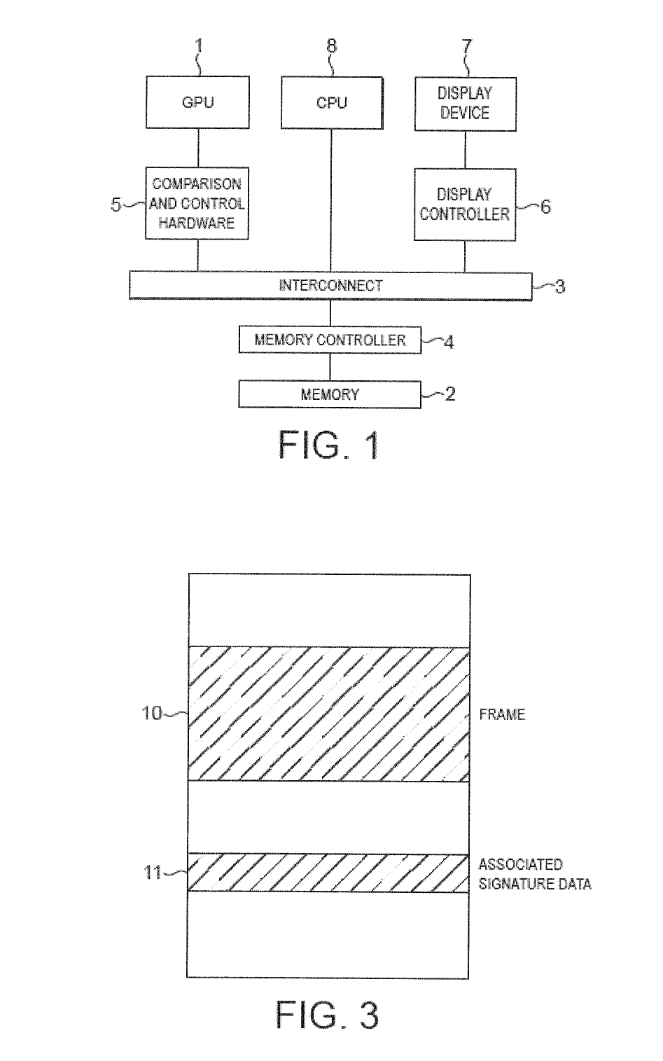

FIG. 1 shows schematically a graphics processing system that can be operated in accordance with the technology described herein;

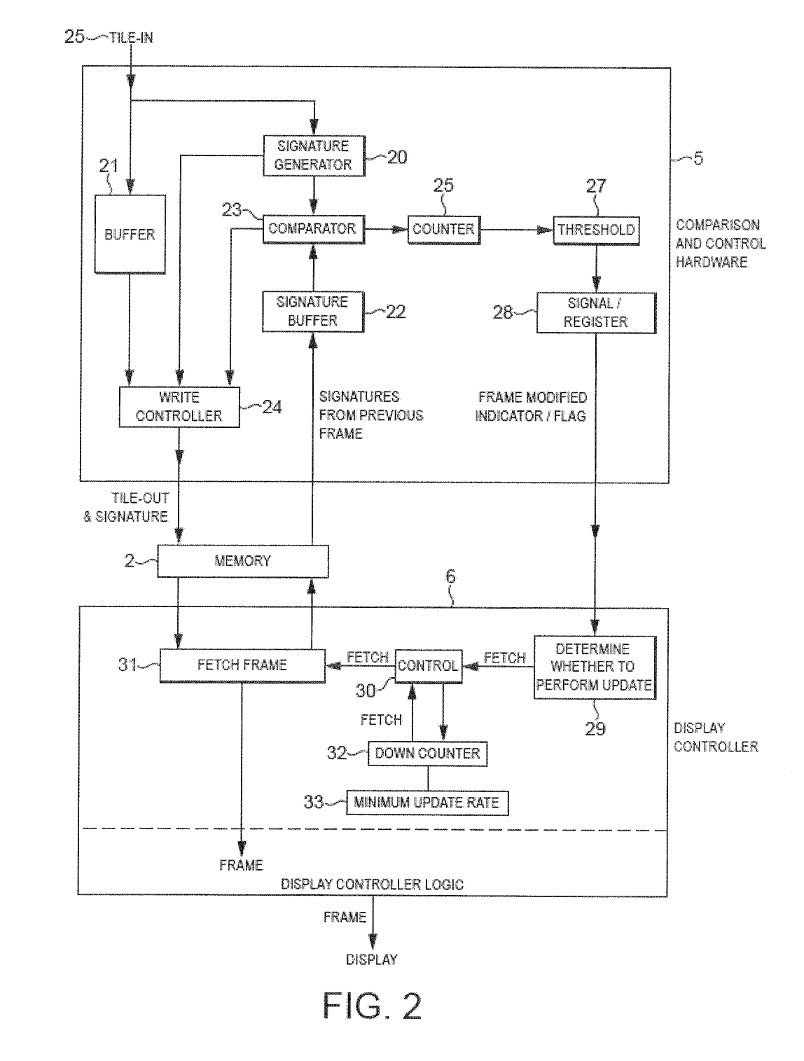

FIG. 2 shows schematically and in more detail a first embodiment of the comparison and control hardware unit and display controller shown in FIG. 1;

FIG. 3 shows schematically how relevant data may be stored in memory in an embodiment of the technology described herein;

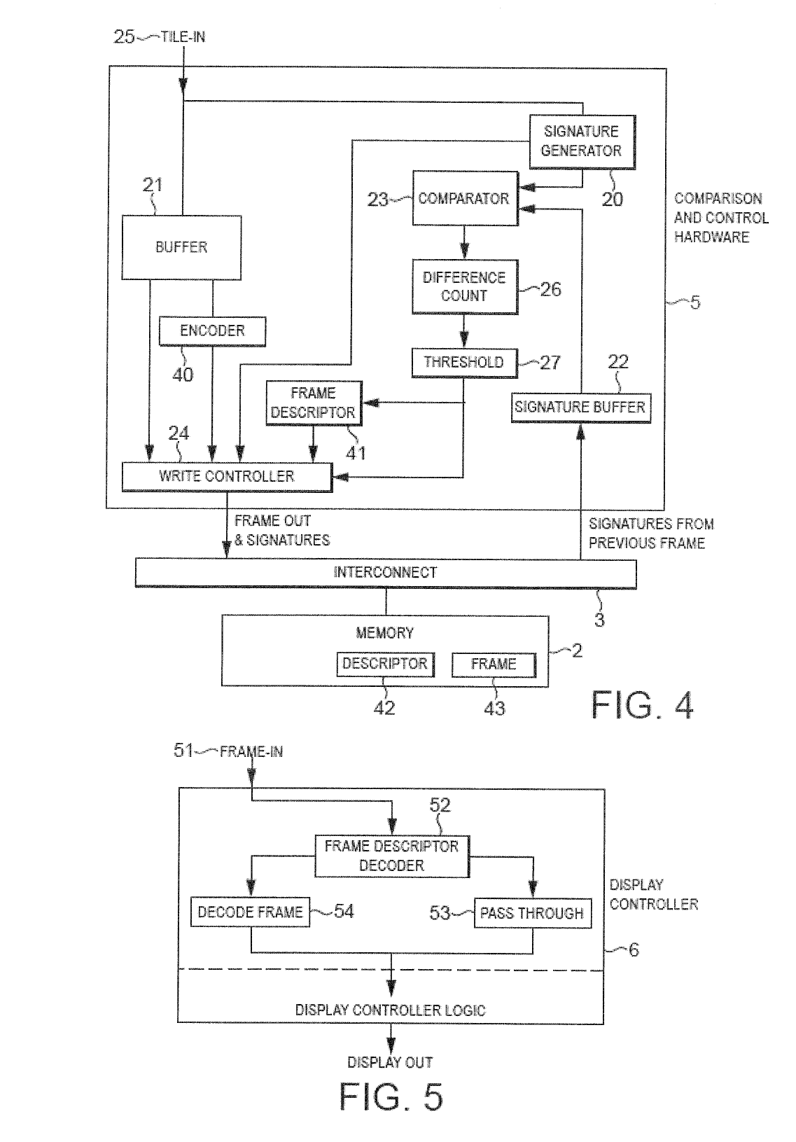

FIGS. 4 and 5 show schematically and in more detail a second embodiment of the comparison and control hardware unit and display controller shown in FIG. 1;

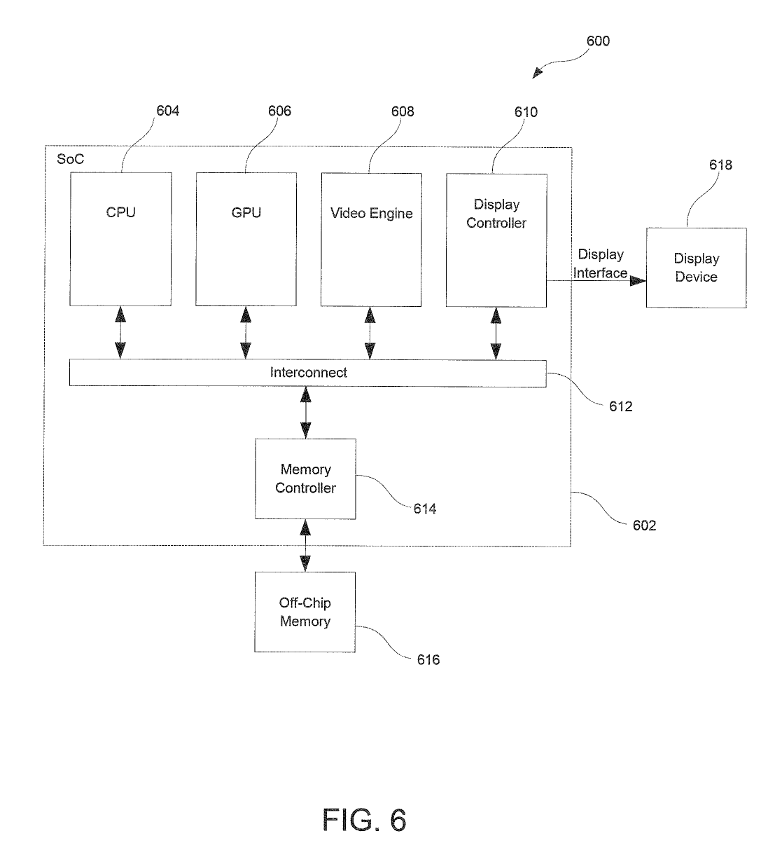

FIG. 6 shows schematically a further data processing system that can be operated in accordance with embodiments of the technology described herein;

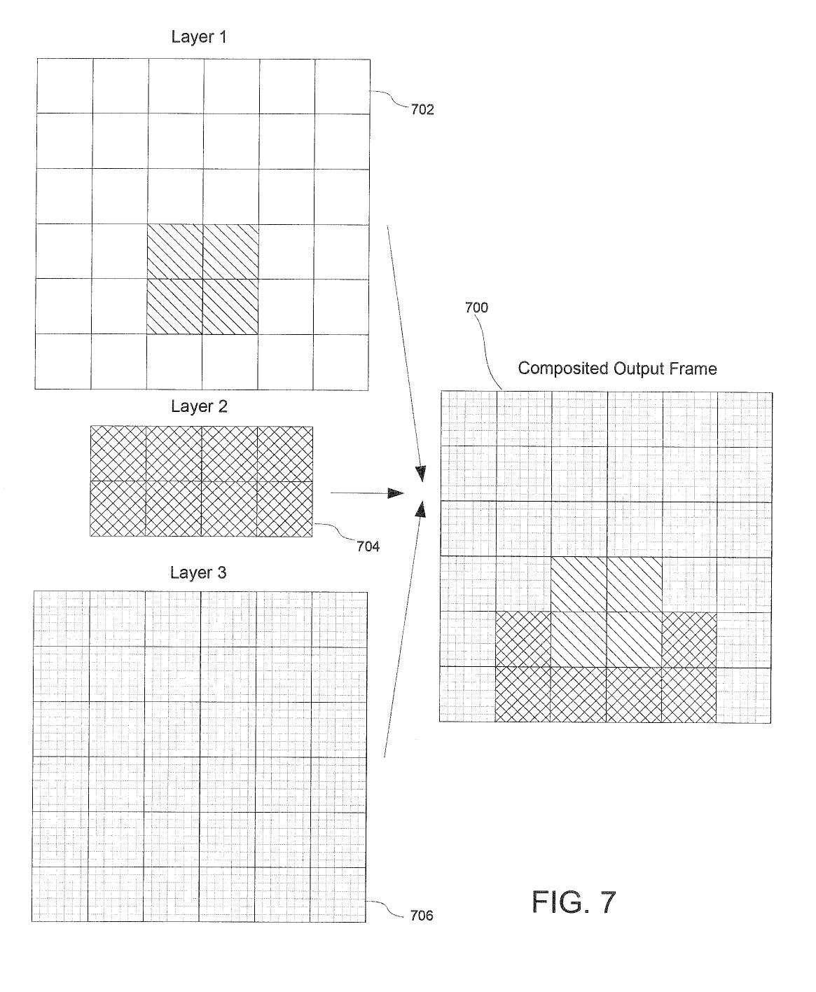

FIG. 7 shows plural input layers that are composited to form a composited output frame in accordance with embodiments of the technology described herein;

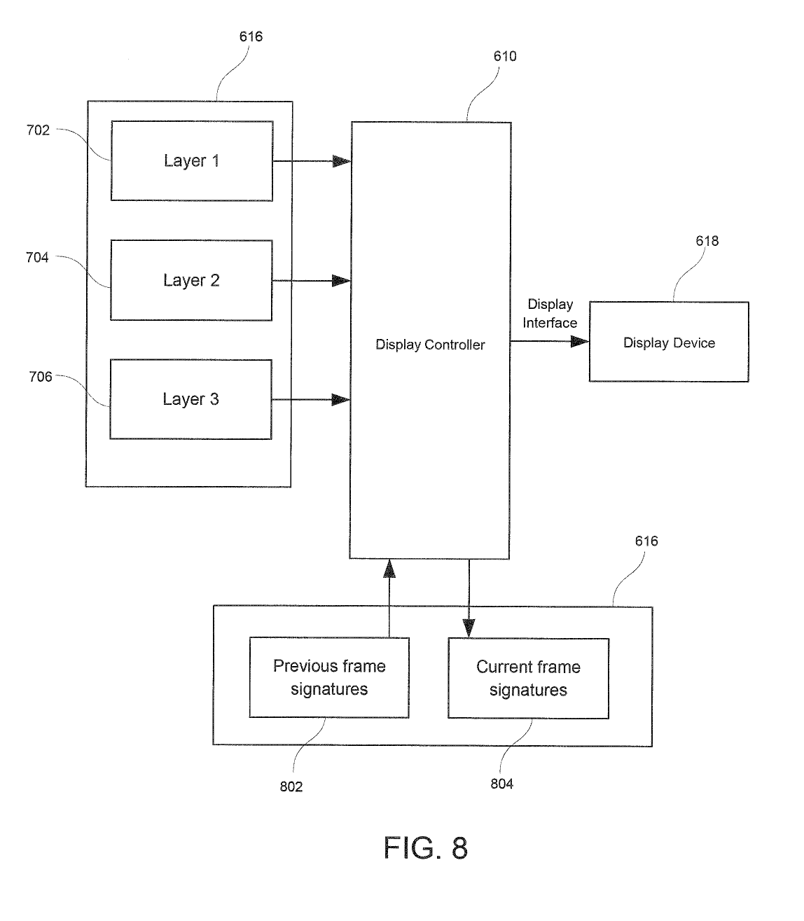

FIG. 8 shows schematically and in more detail an embodiment of the display controller shown in FIG. 6 that composites plural input layers to form a composited output frame;

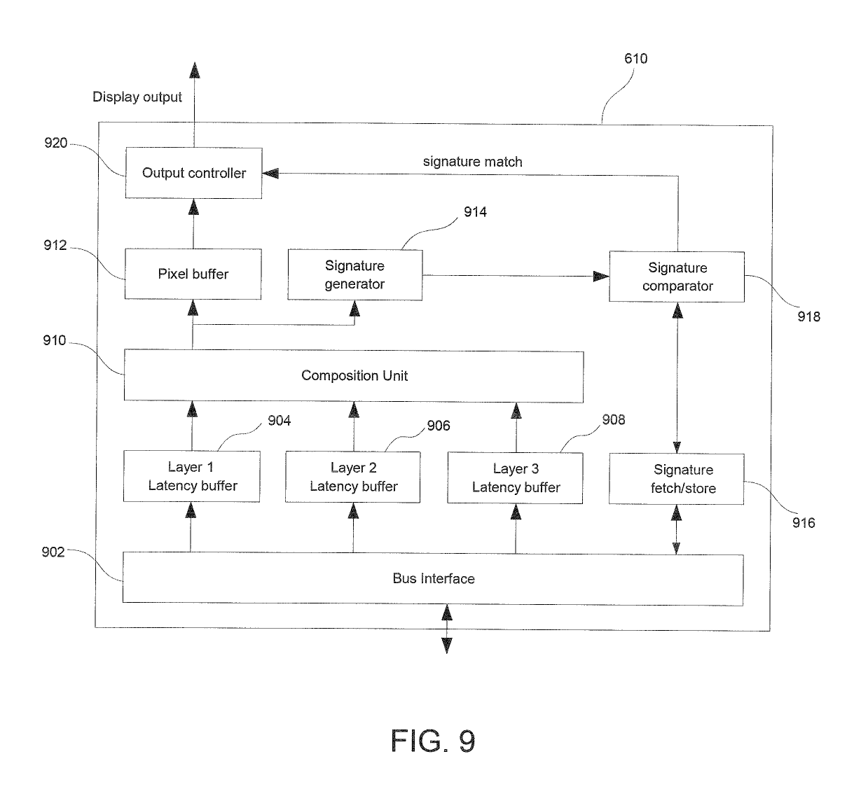

FIG. 9 shows schematically and in more detail a first embodiment of the display controller shown in FIGS. 6 and 8;

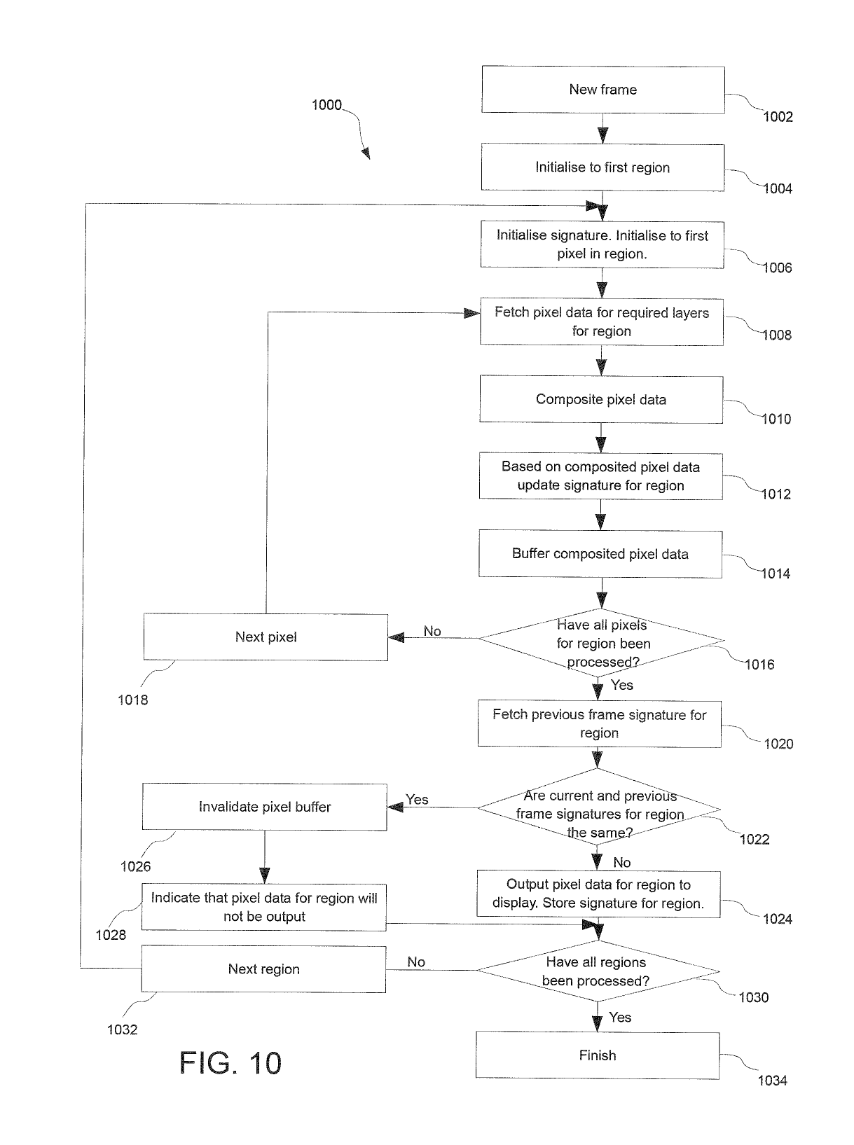

FIG. 10 shows a method of generating signatures for regions of an output frame and controlling the way in which output frames are provided to a display device according to the first embodiment of the display controller shown in FIG. 9;

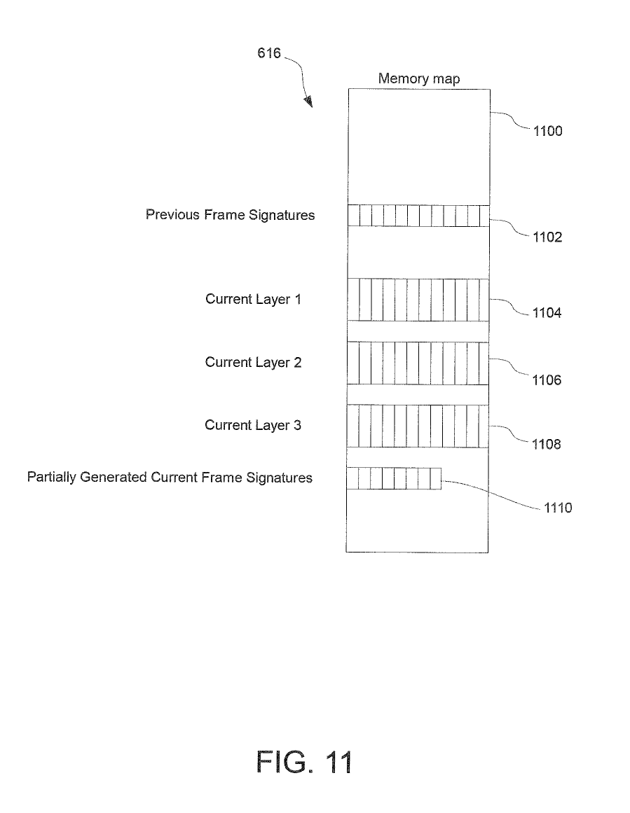

FIG. 11 shows a memory map for storing signatures for regions of a composited output frame and plural input layers according to the first embodiment of the display controller shown in FIG. 9;

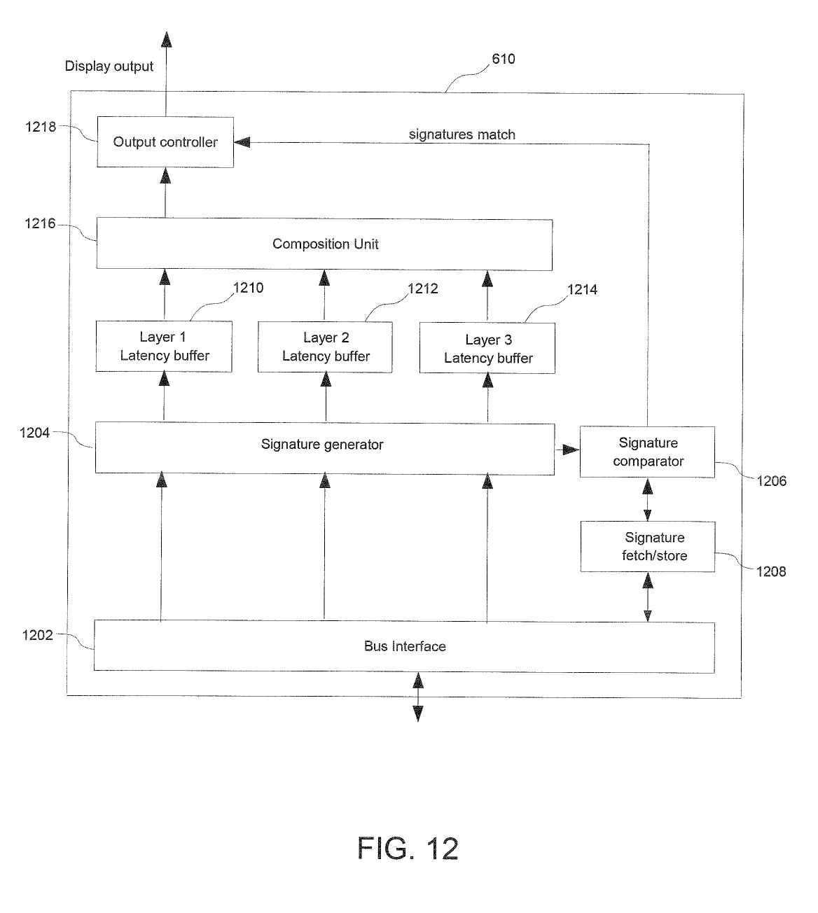

FIG. 12 shows schematically and in more detail a second embodiment of the display controller shown in FIGS. 6 and 8;

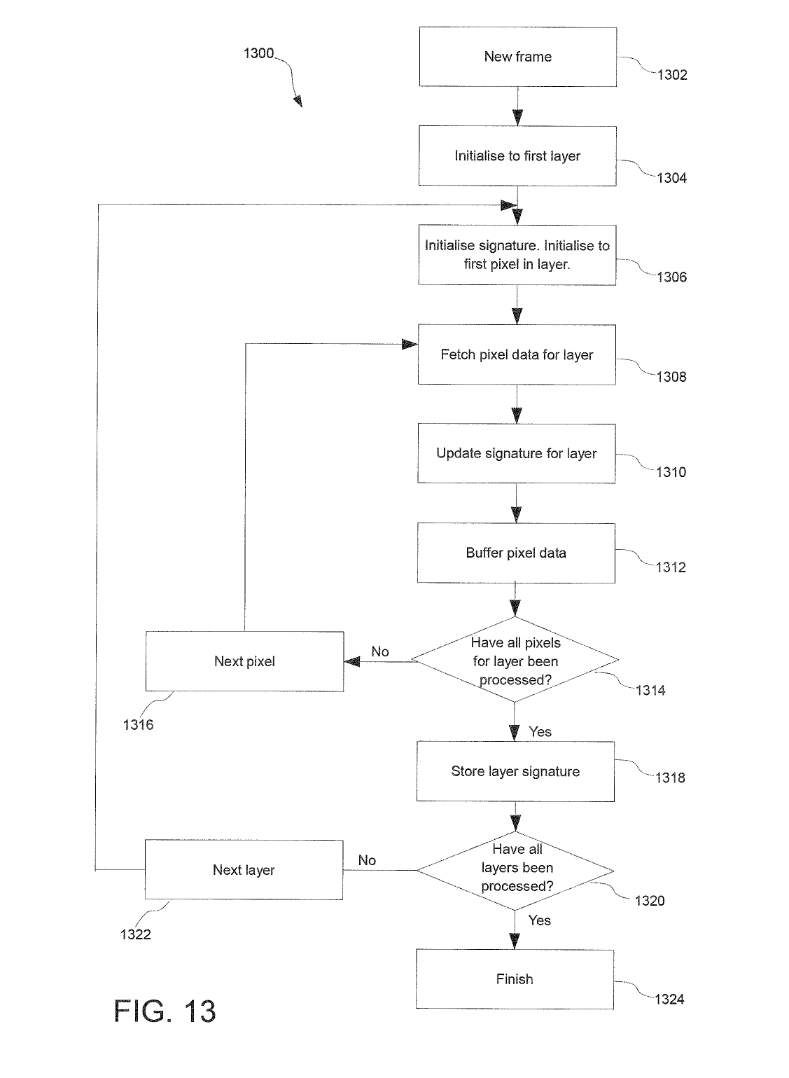

FIG. 13 shows a method of generating signatures for plural input layers according to the second embodiment of the display controller shown in FIG. 12;

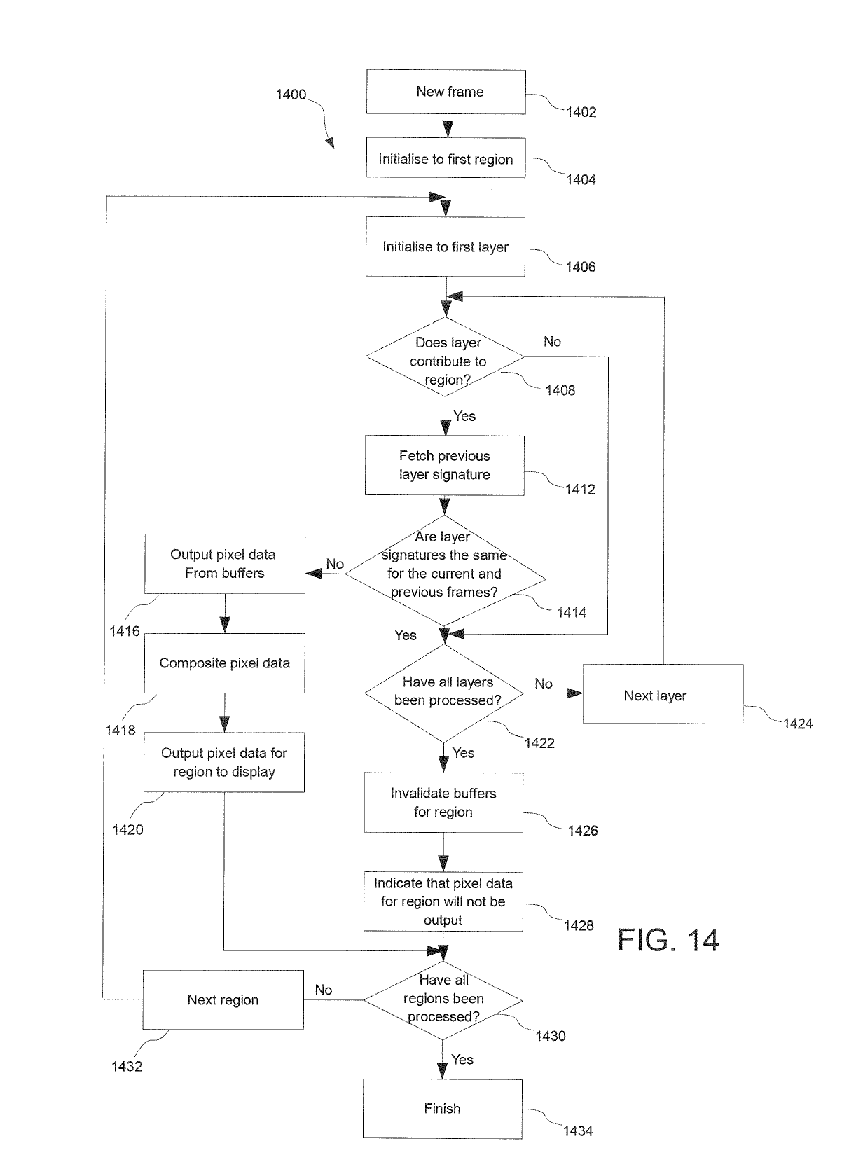

FIG. 14 shows a process of controlling the way in which composited output frames are provided to a display device according to the second embodiment of the display controller shown in FIG. 12;

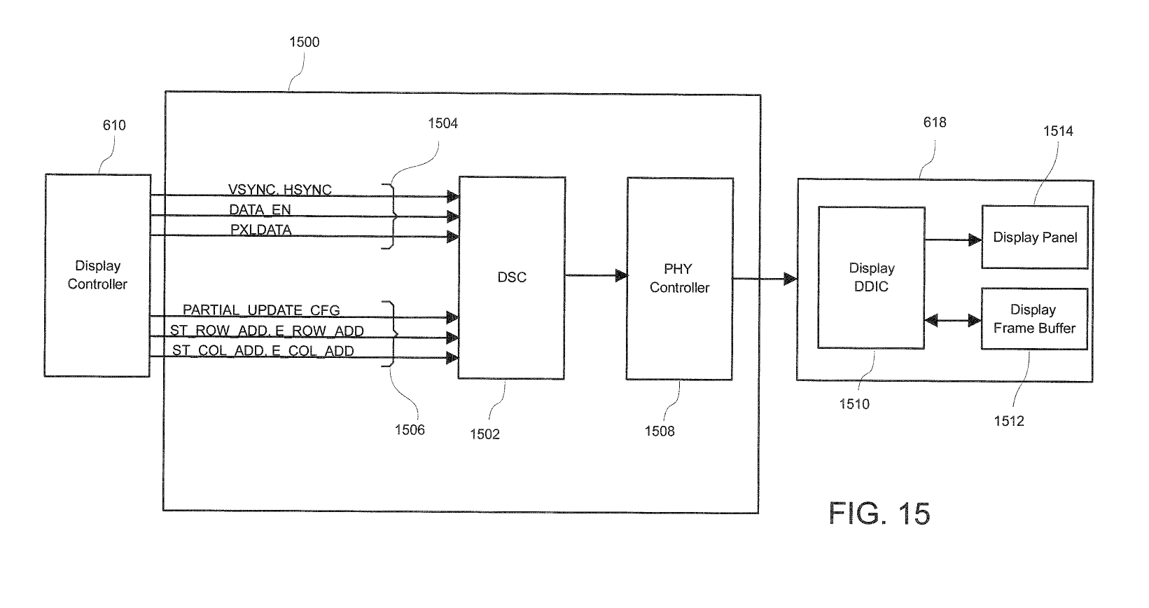

FIG. 15 shows schematically and in more detail an embodiment of a display interface for the display controller and display device shown in FIGS. 6 and 8 that allows partial display updates;

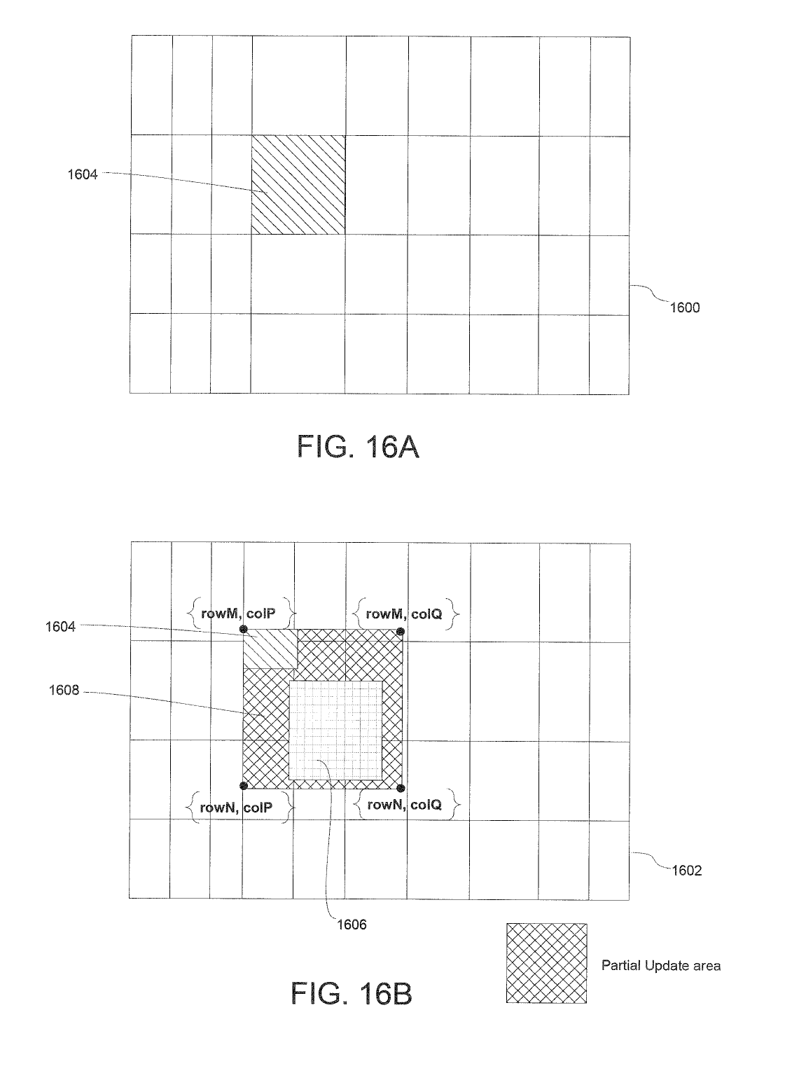

FIG. 16A shows a composited output frame that is currently being displayed and FIG. 16B shows a new composited output frame that is to be displayed by partially updating the display device according to an embodiment of the technology described herein; and

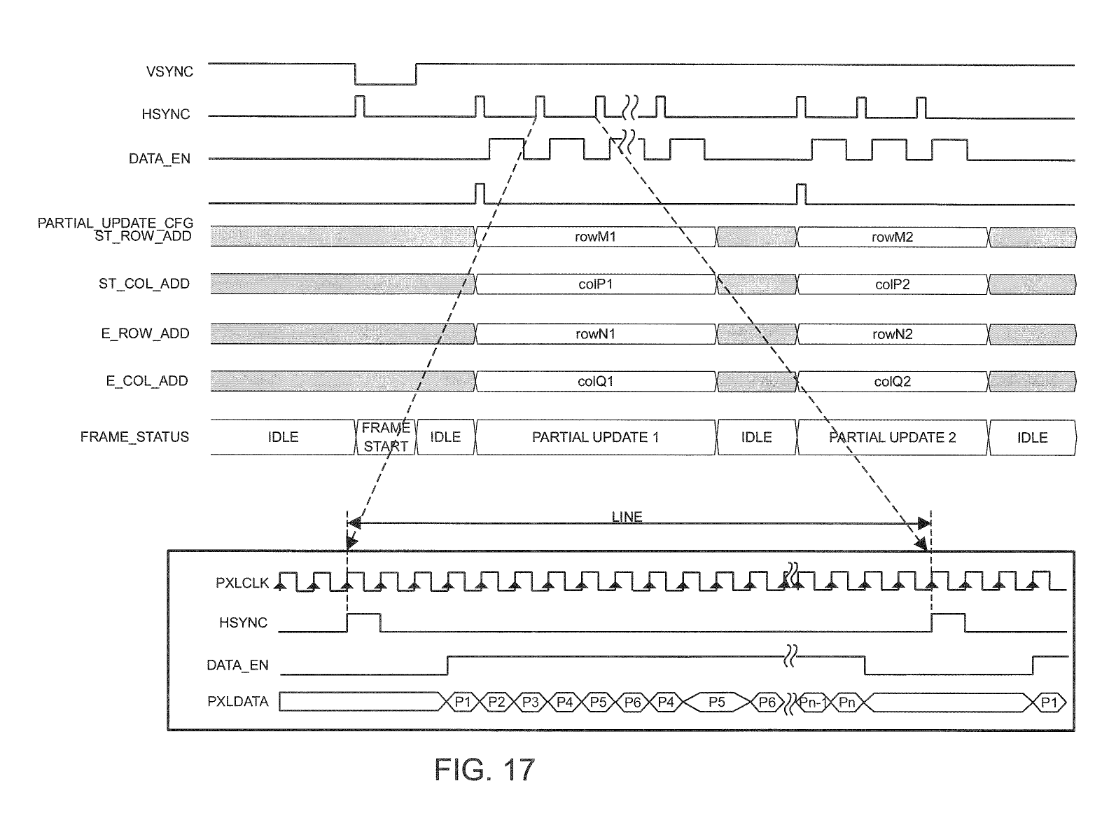

FIG. 17 shows a timing diagram for output frame data signals and partial update control signals in accordance with embodiments of the technology described herein.

Like reference numerals are used for like components throughout the figures, unless otherwise indicated.

A number of embodiments of the technology described herein will now be described. These embodiments will be described primarily with reference to the use of the technology described herein in a graphics processing system, although, as noted above, the technology described herein is applicable to other data processing systems which produce output frames for display, such as video processing systems, composited image processing systems, etc.

Similarly, the following embodiments will be described primarily with reference to the comparison of output frames by comparing rendered tiles generated by a tile-based graphics processor, although again and as noted above, the technology described herein is not limited to such arrangements.

FIG. 1 shows schematically an arrangement of a graphics processing system that is in accordance with the technology described herein.

The graphics processing system includes, as shown in FIG. 1, a tile-based graphics processor or graphics processing unit (GPU) 1, which, as is known in the art, will, inter alia, produce tiles of an output frame intended to be displayed on a display device, such as a screen or printer.

As is known in the art, in such an arrangement, once a tile has been generated by the graphics processor 1, it would then normally be written to a frame buffer in a memory 2 (which memory may be DDR-SDRAM) via an interconnect 3 which is connected to a memory controller 4. Sometime later the frame buffer will, e.g., be read by a display controller 6 and output to a display 7. In the present embodiment, the display device 7 is an LCD screen (other arrangements would, of course, be possible). FIG. 1 also shows for completeness a host CPU 8.

In the present embodiment, and in accordance with the technology described herein, the above process is modified by the use of a comparison and control unit 5, which controls one or more aspects of the way in which the display of the output frames formed by the tiles generated by the graphics processor 1 is carried out.

In essence, and as will be discussed further below, the comparison and control hardware 5 operates to compare successive output frames that are being generated for display, and then controls, in the present embodiment, the rate at which the display device 7 is updated (refreshed) from the frame buffer on the basis of those comparisons. In effect, the comparison and control hardware assesses whether successive output frames differ from each other, and if they do not, the display 7 is not updated (subject to a predetermined minimum update rate).

In this way, the present embodiment can avoid relatively costly updates to the display device 7 when the output frame is not actually changing from one frame to the next. This can save a significant amount of bandwidth and power consumption in relation to the display update operation.

FIG. 2 shows the comparison and control hardware unit 5 and the display controller 6 that are used in the present embodiment in more detail. For clarity purposes, FIG. 2 does not show the interconnect 3 or the memory controller 4, but it will be appreciated that the necessary communication between the comparison and control hardware unit 5, memory 2 and display controller 6 shown in FIG. 2 is performed appropriately via the interconnect 3 and memory controller 4.

In this embodiment, the comparison and control hardware 5 operates to generate for each tile a signature representative of the content of the tile and then compares that signature with the signature of the corresponding tile already stored in the frame buffer to see if the signatures match. Thus, the output frames are compared by comparing rendered tiles generated by the graphics processor 1.

FIG. 3 shows an exemplary memory layout for storing the frame buffer and corresponding tile signatures in the memory 2. The tiles making up the frame are stored in one portion 10 of the memory 2 (thus forming the “frame buffer”) and the associated signatures for the tiles making up the frame are stored in another portion 11 of the memory. (Other arrangements would, of course, be possible.)

As shown in FIG. 2, tile data 25 received by the comparison and control hardware unit 5 from the graphics processor 1 is passed both to a buffer 21 which temporarily stores the tile data while the signature generation and comparison process takes place, and a signature generator 20.

The signature generator 20 operates to generate the necessary signature for the tile. In the present embodiment the signature is in the form of a 64-bit CRC for the tile. (Other signature generation functions and other forms of signature such as hash functions, etc., could also or instead be used, if desired. It would also, for example, be possible to generate a single signature for an RGBA tile, or a separate signature for each colour plane. Similarly, colour conversion could be performed and a separate signature generated for each of Y, U and V.)

Once the signature for the new tile has been generated, it is passed to a signature comparator 23, which operates to compare the signature of the new tile with the signature of the tile already in the frame buffer at the tile position for the tile in question.

The signatures for plural tiles from the previous frame are cached in a signature buffer 22 (this buffer may be implemented in a number of ways, e.g. buffer or cache) of the comparison and control hardware unit 5 to facilitate their retrieval in operation of the system, and so the signature comparator 23 fetches the relevant signature from the signature buffer 22 if it is present there (or triggers a fetch of the signature from the main memory 2, as is known in the art), and compares the signature of the previous frame's tile with the signature received from the signature generator to see if there is a match.

If the signatures are found not to match, then a counter 26 is updated. The counter 26 thus keeps a count of how many tiles have been found not to match for a respective pair of output frames being compared. The counter 26 is reset to zero each time a new output frame is started.

The count of mis-matching tiles for the current frame that is being maintained by the counter 26 is compared to a predetermined threshold count value or tidemark in a comparator 27. If the count of mis-matching tiles for the output frames being compared is found to exceed the threshold value, then it is assumed that the two output frames being compared are different, i.e. the image has been modified as between the two output frames being compared, and so an appropriate “frame-modified” indicator (flag) is set in a register 28. The “frame-modified” indicator is provided as an input to a control unit 29 of the display controller 6.

The control unit 29 operates to trigger an update of the display 7 from the frame buffer in the memory 2 if the “frame-modified” indicator is in its “set” (i.e. “do an update”) state when the new output frame has been completed in the frame buffer.

To facilitate this operation, the frame-modified indicator is reset whenever the frame buffer is output to the display device 7, and then, as discussed above, changed to its set state when a sufficient number of tiles have been found to differ between the two output frames being compared.

Then, once a new output frame has been finished and is stored in the frame buffer, the controller 29 checks the state of the frame-modified indicator, and triggers the updating of the new output frame from the frame buffer to the display 7 to update the display if the frame-modified indicator is set to show that the new frame differs from the previous frame.

The number of the tiles that must differ to trigger a determination that the output frames differ (and thus that the display should be updated) can be set as desired, but should, for example, comprise a suitably small percentage of the tiles that make up an output frame.

In one arrangement it is assumed that the output frames differ (i.e. a display update is triggered) if one pair of tiles being compared is found to differ (i.e. such that, in effect, the threshold number of tiles that must differ to trigger a frame update is one). In this case, the counter 26 and threshold comparator 27 could be eliminated, and the comparator 23 could be configured simply to set the frame-modified indicator to trigger a display update as soon as it is found that one pair of the tiles making up the output frames being compared differ from each other.

The control unit 29 of the display controller 6 triggers a display update by providing a “fetch” control signal to a further control unit 30 that controls the fetching of new frames from the frame buffer for provision to the display device 7 in dependence upon the control inputs it receives.

In this way, the updating of output frames to the display device 7 is controlled in dependence upon the result of the comparison of the output frames by the comparison and control hardware 5 and in particular on the basis of whether the two output frames are to be considered to be the same or not.

As shown in FIG. 2, the control unit 30 of the display controller 6 controls a fetch element 31 which will read an output frame from the frame buffer in the memory 2 and provide that output frame via the appropriate display controller logic to the display device 7 for display. In this way, the control unit 30 controls the updating (or not) of a new frame to the display 7.

The control unit 30 receives two inputs that can trigger it to trigger a frame update to the display 7. The first such input is the input from the control unit 29 based on the frame-modified indicator from the register 28. The other input to the controller 30 that can trigger it to cause a display update is from a minimum update rate down counter 32.

The minimum update rate down counter 32 is set to a predetermined value specified in a minimum update rate register 33 each time a frame is output to the display device 7 for display, and thereafter counts down from that value until a new output frame is provided to the display device 7 (at which point the minimum update rate down counter is reset to its initial value). If the minimum update rate down counter 32 ever reaches zero, it signals the controller 30 to trigger the writing of an output frame to the display device 7. In this way, the minimum update rate down counter 32 ensures that the display device 7 is updated at a minimum refresh rate, irrespective of the results of the output frame comparisons.

The display controller may also have a maximum refresh rate down counter (not shown), which is similarly reset to a predetermined value whenever an output frame is written to the display device 7 and then counts down to zero thereafter, with the display controller being configured to prevent any further updates to the display device 7 until the maximum refresh rate down counter has reached zero. This will stop the display device 7 being updated at too high a rate in a situation where, for example, the graphics processor 1 is able to generate output frames at much higher rates than in practice are needed for the display device 7.

The initial values that minimum update rate down counter 32 and the maximum update rate down counter (where present) are set to can in an embodiment be set and altered automatically, e.g. and in an embodiment depending upon whether the system is tethered or battery operated and upon the condition of the battery. This is in an embodiment done by providing signalling between the display controller 6 and a power management unit of the system.

The display controller signalling logic necessary to implement the present embodiment may be integrated in the display controller or external to the display controller, as desired.

Instead of, as shown in FIG. 2, using counters and logic, etc., integrated into the comparison and control hardware 5 and display controller 6, it would be possible to configure the comparison and control hardware 5 to, for example, generate an interrupt, and then have the display update rate control and process performed in software, with the processor (e.g. the CPU 8) then signalling to the display controller 6 when to update the display, if desired.

The backlight of the LCD display device 7 may be controlled to reduce the effect of flickering (which may occur when low update rates are being used), e.g. by adjusting the backlight to keep the display brightness constant as the screen fades away. For devices with an integrated display, for example, the characteristics of the display (such as how the colour intensity changes if it isn't refreshed) can be used to determine how the image will fade and thus how the backlight should be controlled to reduce flicker.

As can be seen from the above, in the present embodiment, the display controller 6 does simply not update the LCD display device 7 at the usual constant rate of 60-70 Hz. Instead, differences are detected between the current and subsequent output frames, and if the frames are determined to be the same, the display isn't refreshed, subject to still refreshing the display at a minimum rate to avoid the image fading away or degrading.

In this way, unnecessary refreshes of the display device 7 are avoided, and when the image is static or only changing at a relatively slow rate, the image on the display is updated at a lower rate. This saves power and bandwidth in the display device 7, the frame buffer memory, the interconnect, and the display controller 6, etc.

Furthermore, this is achieved without any modification or particular operation of the application or operating system, can provide an immediate response whenever the output frame changes, and can be used to ensure as lower an update rate as possible without flickering or slow response.

As well as operating in the above manner to reduce the refresh (update) rate of the display device 7, the present embodiment also operates to reduce the number of frame buffer write transactions whenever possible. This is achieved by using the tile signature comparison process to also control whether a new tile is written to the frame buffer or not.

In particular, if the signature comparison process determines that the signatures of the two tiles being compared match (i.e. the new tile should be considered to be the same as the corresponding tile (the tile in the same tile position) that is already stored in the frame buffer), then the new tile is not written to the frame buffer, but instead the existing tile is retained in the frame buffer for that tile position.

In this way, the present embodiment can avoid write traffic for sections (tiles) of the frame buffer that don't actually change from one frame to the next. This can save a significant amount of bandwidth and power consumption in relation to the frame buffer operation.

On the other hand, if the signatures do not match, then the new tile is written to the frame buffer and the generated signature for the tile is also written to memory.

This operation is achieved by the signature comparator 23, if it finds that the tiles' signatures do not match, controlling a write controller 24 to write the new tile and its signature to the frame buffer and associated signature data store in the memory 2. On the other hand, if the signature comparator 23 finds that the signature of the new tile matches the signature of the tile already stored in the frame buffer (i.e. that the tiles should be considered to be the same), then the write controller 24 invalidates the tile and no data is written to the frame buffer (i.e. the existing tile is allowed to remain in the frame buffer and its signature is retained).

In this way, a tile is only written to the frame buffer in the memory 2 if it is found that by the signature comparison to differ from a tile that is already stored in the memory 2. This helps to reduce the number of write transactions to the memory 2 as a frame is being generated.

In the present embodiment, to stop incorrectly matched tiles from existing for too long a long period of time in the frame buffer, the ability of the signature comparison to prevent a tile being written to the frame buffer is periodically disabled (in an embodiment once a second for each stored tile in the frame buffer). This then means that when a tile for which the ability of the signature comparison to prevent a tile being written to the frame buffer has been disabled is newly generated, the newly generated tile will inevitably be written to the frame buffer in the memory 2. In this way, it can be ensured that incorrectly matched tiles will over time always be replaced with completely new (and therefore correct) tiles in the frame buffer.

In the present embodiment, the ability of the signature comparison to prevent a tile being written to the frame buffer for the stored tiles is disabled in a predetermined, cyclic, sequence, so that each second (and/or over a set of say, 25 or 30 frames), each individual tile position will always have a new tile written for it once.

In an embodiment, the tile signatures that are generated for use in the technology described herein are “salted” (i.e. have another number (a salt value) added to the generated signature value) when they are created. The salt value may conveniently be, e.g., the output frame number since boot, or a random value. This will, as is known in the art, help to make any error caused by any inaccuracies in the comparison process of the technology described herein non-deterministic.

Although in the above embodiment it is the display of the entire output frame that is updated (or not), the technology described herein may also be used to control the updating of only parts of the output display where the display process supports such operation. This will be the case, for example, for display interconnects that support partial frame updates. Equally, in some displays, the LCD controller can skip lines that have not changed since the last frame by toggling a horizontal blank signal quickly without sending the data for the scan line. It would also be possible to modify the interface between the display and the display controller so as to be able to update only parts of the output frame that have been changed, if desired.

This could be used, for example, for displays with integrated memory, as these displays will allow modifying parts of the display image at a time through the bus.

In this case, the tile comparison process could be used to assess whether particular regions of the output frame have changed or not, and then to control the updating of those particular regions only in the manner of the present embodiment.

For example, the comparison and control hardware could keep track of which regions of the display of the output frame have been modified as between the output frames being compared, and force a display refresh for those regions that have been modified, but otherwise refresh the displayed image at a low rate for regions of the image that remain unmodified. This would be particularly useful for displays that support partial updates.

In this case, the tile comparison process need not be carried out for each and every tile that is generated, but may be done for the desired regions of the display only, if desired.

Where the technology described herein is being used to update only portions of the display in this fashion, then in an embodiment the brightness of the portion of the image that is to be updated is modified (for example by changing the gamma of the image portion in the display controller, or by controlling the backlight, and/or by manipulating the colours) so that it has the same brightness as the rest of the image. This will help to prevent distortions to the image caused by updating only some but not all of the displayed image.

In the above embodiment, the rate at which the display 7 is updated from the frame buffer is controlled on the basis of the output frame comparisons. In another embodiment of the technology described herein, the comparison and control hardware 5 is operable to vary the format in which the output frame is stored in the frame buffer on the basis of the output frame comparisons.

The Applicants have recognised that if the output frame is changing rapidly or significantly from frame to frame, the user viewing the frames will be unable to perceive much detail, whereas if the image is static, a higher quality image may be desirable. This second embodiment of the technology described herein exploits this by varying the frame buffer format that is used in dependence upon whether the output frame comparisons indicate that the output frames are changing significantly or are static.

FIGS. 4 and 5 show the configurations of the comparison and control hardware 5 and the display controller 6, respectively, in this embodiment. (The system of this embodiment is otherwise configured as shown in FIG. 1.)

As shown in FIG. 4, in this embodiment, the comparison and control hardware 5 receives as its input tiles 25 from the graphics processor 1. Each tile is again then temporarily stored in a buffer 21 and passed to a signature generator 20.

The buffer 21 buffers a complete frame, which frame is then written out as a complete frame to the frame buffer in the memory 2 when the complete frame is stored in the buffer 21.

The signature generated for a new tile in the signature generator 20 is again passed to a comparator 23, where it is compared to the signature of the corresponding tile in the frame buffer (which may be retrieved from a signature buffer 22 or, if necessary, from the memory 2, as discussed above).

As in the preceding embodiment, if the comparator 23 finds that the signatures do not match, it increments a counter 26 which keeps a count of the number of tiles that have been found not to match for the output frame in question. This counter 26 is again reset to zero each time a new output frame is started, and then counts the number of unmatching tiles for the frame being processed.

The count of mis-matching tiles for the current frame is again compared to a predetermined threshold count value or tidemark in a comparator 27. If the count of mis-matching tiles for the output frame being compared is found to exceed the threshold value, then it is assumed that the two output frames being compared are significantly different (i.e. the image is changing significantly as between the two frames). This then triggers the storing of the output frame in the frame buffer in a lower quality format. This process will now be described.

As shown in FIG. 4, the frame that is stored in the buffer 21 may either be passed directly from the buffer 21 to the write controller 24 that writes the frame to the frame buffer in the memory 2, or it may be passed to the write controller 24 via an encoder 40 that is operable to encode the frame from the buffer 21 into a different format.

In the present embodiment, it is assumed that the tiles are produced by the graphics processor in an RGB 8:8:8 or RGB 10:10:10 format. This is a higher quality format, but the additional quality can only really be perceived if the image is static. The encoder 40 therefore operates to convert the frame (tiles) from this format into a lower quality, lossy compressed, format, in this case YUV 4:2:0 (which is often used for video where the image is constantly moving).

The write controller 24 is then controlled to store either the original, high quality format frame (tiles) directly from the buffer 21, or the lower quality format frame (tiles) from the encoder 40 by the threshold comparator 27. In particular, if the number of mis-matching tiles exceeds the threshold value, the write controller is triggered to store the output from the encoder 40 in the frame buffer (i.e. such that the lower quality format is used) and vice-versa.

The threshold mis-matching tile value to trigger the use of the lower quality format can be selected as desired. It should be a higher value than the value required to trigger a display update in the previous embodiment.

As shown in FIG. 4, as well as the output frame itself being written to the frame buffer (in the selected format), a frame descriptor unit 41 generates a description or identifier (meta-data) 42 that indicates the format that the frame is being stored in. The frame format descriptor 42 is then stored in association with the frame 43 in the memory 2 to allow the display controller to identify the format that the frame has been stored in the frame buffer (as will be discussed further below). The frame format descriptor information 42 may be an identifier indicating the format used, and/or an algorithm indicating how the data should be converted to the desired display format, etc. Alternatively, the frame format could be signalled to the display controller 6, if desired.

In an alternative arrangement, the comparator 27 could control the graphics processor 1 to produce its tiles in the lower quality format directly, where that is required.

FIG. 5 shows the corresponding display controller operation. As shown in FIG. 5, when the display controller receives a frame 51 from the frame buffer for display, it first checks the format descriptor 42 associated with the frame in question in a frame descriptor decoder 52. As a result of that decoding, it then either passes the frame in the form it is received via a pass-through path 53 to the display controller logic for display, or, if the input frame is in its encoded format, passes it to a frame decoder 54 for converting to the appropriate format for display before again passing the frame to the display controller logic and the display.

The display controller may conveniently, for example, read the frame format descriptor during the VSYNC period immediately after the frame buffer swop before then reading and decoding the actual frame data. This makes it possible to straightforwardly switch frame buffer formats on-the-fly from frame to frame.

It can be seen therefore that in this embodiment the comparison and control hardware 5 is operable to store the frame in the frame buffer in a desired format together with control information to indicate which format has been written. The display controller 6 then reads the information describing the frame buffer format, reads out the frame buffer data, and, if necessary, converts the frame buffer format to the desired output format. The different formats to use are based on the comparison of the output frames to see whether successive output frames differ significantly from each other or not.

This embodiment accordingly allows a lower image quality frame buffer format to be used when the image is determined to be changing rapidly (such that the user will be unable to receive a great deal of detail and therefore a lower image quality will be acceptable), thereby reducing power consumption and bandwidth, but while still being able to revert to a higher quality image format when the image becomes static (and thus the higher quality of the image can be perceived by the user).

By being able to dynamically alter the frame buffer format used based on the rate of change of the image in this way, an arrangement which improves image quality compared with frame buffers that always use lower quality format, but which also reduces memory bandwidth compared to systems which would always use a higher quality frame buffer format, is provided.

Although in the above embodiment, the higher quality format is described as being RGB, and the lower quality format as being YUV, other arrangements to provide higher and lower quality formats could be used if desired. For example, other compressed, lossy formats could be used for the lower quality formats. It would also, for example, be possible to use different frame buffer resolutions, and/or dynamic ranges (colour depths), etc., to provide the higher and lower quality formats, if desired. Where the image is rendered at a lower resolution, then the display controller or another system component could scale the image to full size for display.

It would also be possible to provide only partial frame updates, e.g. such that only a region of each new frame is generated, rather than generating the entire new frame, where a lower quality format is desired, with the higher quality format then being the generation of the entire new frame each time.

Equally, although the above embodiments are described with reference to selecting a particular format for the entire frame that is stored in the frame buffer, it would be possible to vary the format for particular regions of the frame only (i.e. to have different regions of the frame stored in different formats). This could be done by using the tile comparisons to identify those regions of the frame that are changing more significantly and then using a different format for those regions of the frame only, in a similar manner to the process discussed above for updating part of the display only.

In this case, the buffer 21 could, for example, simply store part of the frame, or part of the frame that is stored in the frame buffer 21 could be passed through the encoder 40 for writing to the frame buffer, with the remainder of the frame not being so-encoded before it is written to the frame buffer. Similarly, the frame descriptor 42 could be configured to appropriately indicate the region or regions of the frame and what format they are encoded in.

Although the above embodiment has been described as being an alternative arrangement to the control of the display update rate based on the frame comparisons, as will be appreciated by those skilled in the art, it would be possible to perform both the format selection and display update rate control based on the frame comparisons if desired. Thus in an embodiment, the frame comparisons are used to both control the rate at which the display is updated and to select the format that the frame is stored in the frame buffer. In this case two different mis-matching tile count thresholds are in an embodiment used, a first, lower threshold to trigger frame updates, and a second, higher threshold to trigger the use of a lower quality frame buffer format.

Although the technology described herein has been described above with particular reference to the controlling of the display update rate and/or the frame buffer format based on the comparisons of the output frames, the comparisons of the output frames could be used to control other aspects of the system operation as well or instead, if desired. For example, if the output frame comparisons show that the image is static for a period of time, the graphics processor could be controlled to reduce the rate at which it produces the output frames, thereby saving power. Similarly, if it is found by the output frame comparisons that the output image is static for a period of time, then the system could be controlled to re-render the frame using better anti-aliasing, thereby increasing the perceived image quality.

A number of other alternatives and arrangements of the above embodiments and of the technology described herein could be used if desired.

For example, it would be possible to provide hardware registers that enable/disable the tile signature comparisons for particular frame regions, such that the signature generation and comparison is only performed for a tile if the register for the frame region in which the tile resides is set.

The driver for the graphics processor (for example) could then be configured to allow software applications to access and set these tile signature enable/disable registers, thereby giving the software application the opportunity to control directly whether or not and where (for which frame regions) the signature generation and comparisons take place. This would allow a software application to, for example, control how and whether the signature comparison is performed. This could then be used, e.g., to eliminate the power consumed by the signature comparison for a region of the output frame the application “knows” will be static.

The number of such registers may chosen, for example, as a trade-off between the extra logic required implementing and using them and the desired granularity of control.

Although the present embodiments have been described above with particular reference to the comparison of rendered tiles to be written to the frame buffer, as discussed herein it is not necessary that the data blocks forming regions of the output data array that are compared (and e.g. have signatures generated for them) in the manner of the technology described herein correspond exactly to rendered tiles generated by the graphics processor.

For example, the data blocks that are considered and compared in the manner of the technology described herein could be made up of plural rendered tiles and/or could comprise sub-portions of a rendered tile. Indeed, different data block sizes may be used for different regions of the same output array (e.g. output frame) and/or the data block size and shape could be adaptively changed, if desired.

Where a data block size that does not correspond exactly to the size of a rendered tile is being used, then the comparison and control hardware unit 5 may conveniently be configured to, in effect, assemble or generate the appropriate data blocks (and, e.g., signatures for those data blocks) from the data, such as the rendered tiles, that it receives from the graphics processor (or other processor providing it data for an output array).

Although the present embodiments have been described above with particular reference to a graphics processing system and the generation of output frames by a graphics processor, the Applicants have recognised that the frame comparison and control processes of the technology described herein could equally be used for other systems that generate output frames for display, particularly where the output frame data is processed in blocks in a manner similar to the tiles of a tile-based graphics processor, such as a video processor (video codec) producing video blocks for a video frame buffer, and for graphics processor image composition. Thus the processes of the technology described herein may be applied equally to the image that is being, for example, generated by a video processor.

Embodiments in which a display controller compares output frames to be displayed and then controls at least one aspect of the way in which the output frames are provided for display on a display device on the basis of the comparison (i.e. in which the comparison and control hardware forms part of a display controller) will now be described.

FIG. 6 shows schematically an embodiment of a data processing system 600 that comprises a system on chip (SoC) 602. The system 600 also comprises off-chip (main) memory 616 and a display device 618. In this embodiment, the display device 618 comprises an LCD screen, although other display screen technologies could, of course, be used.

The SoC 602 comprises a host central processing unit (CPU) 604, a graphics processing unit (GPU) 606, a video processor in the form of a video (codec) engine 608, a display controller 610, an interconnect 612 and a memory controller 614. As is shown in FIG. 6, the CPU 604, GPU 606, video engine 608, and display controller 610 communicate with each other via the interconnect 612 and with the memory 616 via the interconnect 612 and memory controller 614. The display controller 610 also communicates with the display device 618 via a display interface.

In this embodiment, the CPU 604, GPU 606 and/or video engine 608 can each generate frames of image data. The various frames are stored in frame buffers in memory 616. The various frames are then read and composited by the display controller 610 and the composited output frame is then provided to the display device 618 for display and/or written back to a frame buffer in memory 616 prior to being output for display.

To illustrate the composition process performed by the display controller 610, FIG. 7 shows an embodiment in which plural input layers (frames) are composited to form a composited output frame 700. In this embodiment, the layers comprise a first layer 702, a second layer 704 and a third layer 706. The first layer 702 is formed of plural tiles of image data which are entirely opaque (shown with shading) and plural tiles of image data which are entirely transparent (shown without shading). The tiles of the second layer 704 and third layer 706 are entirely opaque.

In this embodiment, the display order for the layers is such that the first layer 702 is in the foreground, the second layer 704 is next, and the third layer 706 is in the background. For example, the first layer 702 may relate to an animated alert icon generated by the GPU 606, the second layer 704 may relate to a video application window generated by the video engine 606, and the third layer 706 may relate to a background image provided by the CPU 604.

As is shown in FIG. 7, the first layer 702, second layer 704 and third layer 706 are composited by the display controller 610 to form a composited output frame 700 having the opaque areas of the first layer 702 in front, then the second layer 704, and then the third layer 706 in the background.

Although only three simple layers have been described in this embodiment, it will be appreciated that much more complex and/or many more input layers can be composited in other embodiments of the technology described herein.

FIG. 8 shows in more detail an embodiment of the display controller 610 of FIG. 6 that composites plural input layers to form a composited output frame.

In this embodiment, three layers 702, 704, 706 are composited to provide a composited output frame for display on the display device 618. In this embodiment, the three layers 702, 704, 706 are stored in respective frame buffers in memory 616.

As will be discussed in more detail below, signatures either for regions of the composited output frames, or for the input layers to be composited, are generated by the display controller 610. In the present embodiment, each signature is again in the form of a 64 bit CRC, although other signature generation functions and other forms of signature such as hash functions, etc., could also or instead be used, if desired.

In order to compare output frames, the signatures generated in respect of a previous composited output frame are read in from signature buffers 802 in memory 616. The signatures generated for the current composited output frame are also written back to signature buffers 804 in memory 616 by the display controller 610 for use when processing the next composited output frame.

In this embodiment, the frame buffers and signature buffers are all in the same memory 616. However, other arrangements are possible, such as providing frame buffers and/or signature buffers on the display controller 610. These other arrangements may be useful, for example, where there are relatively fewer signatures (for fewer relatively larger regions) to be considered.

FIG. 9 shows in more detail a first embodiment of the display controller 610 of FIGS. 6 and 8 in which a set of signatures is generated by the display controller 610 for the composited output frame.

In this embodiment, the display controller 610 comprises a bus interface 902, latency buffers 904, 906, 908, and a composition unit 910. The three layers that are composited to form the composited output frame are fetched via the bus interface 902 and are stored in their respective latency buffers 904, 906, 908. The composition unit 910 then composites the layers stored in the latency buffers 904, 906, 908.

In this embodiment, the display controller 610 also comprises a pixel (display position) buffer 912 that stores the composited pixel (display position) data for a line portion of the composited output frame. The display controller 610 also comprises a signature generator 914 that generates a signature for each respective line portion (region) of the composited output frame. In this embodiment, the line portions for which the respective signatures are generated are entire lines. However, other arrangements are possible such as using line portions that are ⅛, ¼ or ½ of a line or using groups of line portions, such as groups of 2 vertically adjacent line portions that are both ½ of a horizontal line.

In this embodiment, the display controller 610 also comprises a signature comparator 918. As will be explained in more detail below, the signatures for the line portions of the current composited output frame are compared by the signature comparator 918 respectively to the signatures for the corresponding line portions of the previous composited output frame.

In this embodiment, the display controller 610 also comprises signature fetch/store circuitry 916. The signatures generated for the previous composited output frame can be read in from memory 616 via the signature fetch/store circuitry 916 and the bus interface 902. Similarly, the signatures for the current composited output frame can be written back to memory 616 via the signature fetch/store circuitry 916 and the bus interface 902.

In this embodiment, the display controller 610 further comprises an output controller 920 that controls whether or not to output the pixel data stored in the pixel buffer on the basis of the signature comparisons.

FIG. 10 shows a method 1000 of generating signatures and controlling the way in which composited output frames are provided to the display device 618 according to the first embodiment of the display controller 610 shown in FIG. 9.

As is shown in FIG. 10, the process begins for a new output frame to be provided in step 1002. Then, in step 1004, the process comprises initialising to the first region of the output frame (e.g. the top line of the output frame) to be provided. Then, in step 1006, the process comprises initialising the signature for that first region and initialising to the first pixel of that first region (e.g. the first pixel of the top line of the output frame to be provided).

Next, in step 1008, the pixel data for the required layers for the first region are fetched from the latency buffers 904,906, 908. Then, in step 1010, the fetched pixel data is composited. Then, in step 1012, the signature for the region is updated based on composited pixel data. Then, in step 1014, the composited pixel data is buffered in the pixel buffer 912.

Next, in step 1016, it is determined whether all of the pixels of the first region have been processed. If there are still some pixels left to be processed, then the next pixel is selected in step 1018 and the process returns to step 1008 to process that next pixel. Conversely, if there are no more pixels left to be processed, then in step 1020, the signature of the corresponding region in the previous frame is fetched using the signature fetch/store circuitry 916.

Next, in step 1022, the signature comparator 918 determines whether the signature generated for the present region in the current composited output frame is the same as the signature for the corresponding region in the previous composited output frame.

If the signatures are not the same, then it is considered that the composited region has changed. In this case, the signature comparator 918 indicates to the output controller 920 in step 1024 that the composited pixel data for the region should be output from the pixel buffer to the display device 618. The signature for the composited region is also output to memory 616 using the signature fetch/store circuitry 916 for use when processing the next frame.

Conversely, if the signatures are the same, then it is considered that the composited region has not changed. In this case, the pixel data for the composited region in the pixel buffer 920 is invalidated in step 1026. The signature comparator 918 also indicates to the output controller 920 in step 1028 that the pixel data for the composited region should not be output to the display device 618.

Next, in step 1030 it is determined whether all of the regions of the output frame have been processed. If there are still some regions of the output frame to be processed, then the next region is selected in step 1032 and the process returns to step 1006 to process the next region. Conversely, if all of the regions of the output frame have been processed then the process finishes at step 1034.

It will be appreciated that the method 1000 of FIG. 10 therefore results in the pixel data for the regions of the output frame that have changed being provided to the display device 618, whereas the pixel data for the regions of the output frame that have not changed is not provided to the display device 618. This partial updating of the display device 618 can significantly reduce display interface power and bandwidth requirements.

FIG. 11 shows a memory map 1100 which shows how the signatures for the regions of the previous composited output frame 1102, the pixel data for the current layers 1104, 1106, 1108, and the partially generated signatures for the current composited output frame 1110 may be stored together in memory 616. However, as discussed above, other arrangements are possible, such as providing frame buffers and/or signature buffers on the display controller 610 itself.

FIG. 12 shows in more detail a second embodiment of the display controller 610 of FIGS. 6 and 8 in which a signature is generated for each layer to be composited rather than for each region of the composited output frame that is formed from those layers.

In this embodiment, the display controller 610 again comprises a bus interface 1202, latency buffers 1210, 1212, 1214, and a composition unit 1216. The three layers are again fetched via a bus interface 1202 and stored in their respective latency buffers 1210, 1212, 1214. The composition unit 1210 then composites the layers stored in the latency buffers 1210, 1212, 1214 to generate a composited output frame.

In this embodiment, the display controller 610 again comprises a signature generator 1204. However, in this embodiment, rather than generating a signature for each line portion of the composited output frame, a signature is generated for each layer before that layer is stored and composited. This process will be explained in more detail below with reference to FIG. 13.

In this embodiment, the display controller 610 again also comprises a signature comparator 1206. In this embodiment, the signatures for the current layers are compared respectively to the signatures for the corresponding previous layers by the signature comparator 1206. This process will be explained in more detail below with reference to FIG. 14.

In this embodiment, the display controller 610 again also comprises signature fetch/store circuitry 1208. The signatures generated for the previous layers can be read in from memory 616 via the signature fetch/store circuitry 1208 and the bus interface 1202. Similarly, the signatures for the current layers can be written back to memory 616 via the signature fetch/store circuitry 1208 and the bus interface 1202 for use when processing the next composited output frame.

In this embodiment, the display controller 610 again further comprises an output controller 1218 that controls the output of the pixel data for composited regions of the current output frame on the basis of the signature comparisons.

As indicated above, FIG. 13 shows a method 1300 of generating signatures for the layers according to the second embodiment of the display controller 610 shown in FIG. 12.

As is shown in FIG. 13, the process begins for a new composited output frame to be provided in step 1302. Then, in step 1304, the process comprises initialising to the first layer (e.g. layer 702 in FIG. 7). Then, in step 1306, the process comprises initialising the signature for the first layer (e.g. the first layer 702 in FIG. 7) and initialising to the first pixel of that first layer (e.g. the top-right pixel of the first layer 702 in FIG. 7). Then, in step 1308, the pixel data for the first pixel is fetched. Then, in step 1310, the signature for the first layer is updated by the signature generator 1204 using the pixel data for the first pixel. Then, in step 1312, the pixel data for the first pixel is buffered in the first latency buffer 1210.

Next, in step 1314, it is determined whether all of the pixels of the first layer have been processed. If there are still some pixels of the first layer left to be processed then the next layer is selected at step 1316 and the process returns to step 1308 to process the next pixel. Conversely, if all of the pixels of the first layer have been processed, then the signature for that layer is stored by the signature fetch/store circuitry 1208 in step 1318.

Next, in step 1320, it is determined whether all of the layers have been processed. If there are still some layers left to be processed then the next layer is selected in step 1322 and the process returns to step 1306 to process the next layer. Conversely, if all of the layers have been processed then the process finishes at step 1324.

As will be appreciated, the result of the method 1300 is a set of signatures for a composited output frame comprising a signature for each layer that is used to form that composited output frame.

FIG. 14 then shows a method 1400 of controlling the way in which composited output frames are provided to the display device 618 according to the second embodiment of the display controller 610 shown in FIG. 12.

As is shown in FIG. 14, the process begins for a new composited output frame to be provided in step 1402. Then, in step 1404, the process comprises initialising to the first region to be processed for the output frame (e.g. the top line of the output frame). Then, in step 1406, the process comprises initialising to the first layer (e.g. layer 702 in FIG. 7).

Next, in step 1408, it is determined whether the first layer contributes to the first region of the output frame. The determination is based on the display order of the layers, the transparencies of the tile regions of the layers, and the relative positions of the layers in the composited output frame.

For example, in the case of output frame 700 shown in FIG. 7, it would be determined that the first layer 702 does not contribute to the top line of the composited output frame since the top line of the first layer 702 is entirely transparent. Similarly, it would be determined that the second layer 704 does not contribute to the top line of the composited output frame since the second layer 704 does not overlay the top line of the composited output frame. Conversely, it would be determined that the third layer 706 does contribute to the top line of the composited output frame since the third layer 706 does overlay the top line of the composited output frame, is opaque and, despite being in the background, is not covered by another layer and so is visible in the output frame.

If a given layer does not contribute to the first region of the output frame, then the process skips to step 1422. If a given layer does contribute to the first region of the output frame, then the signature for that layer is fetched by the signature fetch/store circuitry 1208 from memory 616 in step 1412.

Next, in step 1414, it is determined whether the signature generated for the present layer in the current frame is the same as the signature for the corresponding layer in the previous frame.

If the signatures are not the same, then it is considered that the composited region will have changed. In this case, the pixel data for all layers that contribute to that region in the output frame are output from the latency buffers 1210,1212,1214 in step 1416. Then, in step 1418, the pixel data is composited and, in step 1420, the composited pixel data for the region is output to the display 618.

If the signatures are the same (or if it was determined in step 1408 that the layer does not contribute to the first region of the output frame), it is then determined in step 1422 whether all of the layers for the region have been processed.

If there are still some layers for the region to be processed, then the next layer is selected at step 1424 and the process returns to step 1408 to process the next layer. Conversely, if all of the layers for the region have been processed, then it can be considered that the composited region will not change. In this case, the pixel data for the first region for all of the layers is invalidated in step 1426, and the signature comparator 1206 indicates to the output controller 1218 in step 1428 that the pixel data for the region should not be output to the display device 618.

Next, in step 1430 it is determined whether all of the regions of the composited output frame have been processed. If there are still some regions of the composited output frame to be processed, then the next region is selected in step 1432 and the process returns to step 1406 to process the next region. Conversely, if all of the regions of the composited output frame have been processed then the method finishes at step 1434.

It will be appreciated that the method of FIG. 14 again results in the pixel data for the regions of the composited output frame that have changed being provided to the display device 618 whereas the pixel data for the regions of the composited output frame that have not changed is not provided to the display device 618. Again, this partial updating of the display device 618 can significantly reduce display interface power and bandwidth requirements.

FIG. 15 shows in more detail an embodiment of a display interface 1500 for a display controller 610 and display device 618 that support partial output frame updates.

As is shown in FIG. 15, the display interface 1500 comprises a VESA display stream compressor (DSC) 1502 that receives output frame data signals 1504 and partial update control signals 1506 from the display controller 610.

In this embodiment, the output frame data signals 1504 comprise a vertical synchronisation signal (VSYNC), a horizontal synchronisation signal (HSYNC), a data enable signal (DATA_EN), and the output frame pixel data itself (PXLDATA).

In this embodiment, the partial update control signal 1506 comprises a partial update enable signal (PARTIAL_UPDATE_CFG), a partial update area row start address (ST_ROW_ADD), a partial update area update row end address (E_ROW_ADD), a partial update area column start address (ST_COL_ADD), and a partial update area column end address (E_COL_ADD).

The DSC 1502 receives the signals from the display controller 610 and outputs a single stream of compressed output frame data for transmission to the display device 618.

In this embodiment, the display interface 1500 further comprises a physical layer (PHY) controller 1508 that receives the stream of compressed output frame data and transmits the stream of compressed output data to the display device 618. The PHY controller may be a wired or wireless (e.g. Wi-Fi) PHY controller.

In this embodiment, the display device 618 comprises a controller 1510 for the display device 618, an LCD display panel 1514 that displays an image based on the stream of compressed output data, and a display frame buffer 1512 that stores the data for the output frame currently being displayed. As will be appreciated, the output frame which is currently being displayed can be formed from part of the current output frame that has changed and parts of one or more previous output frames that have not changed.

To illustrate the partial update process in more detail, FIG. 16A shows an output frame 1600 in which an object 1604, such as a video application window, is currently being displayed. FIG. 16B then shows the new output frame 1602 to be displayed in which the object 1604 has been resized and in which a new object 1606, such as an alert icon, is to be displayed. As is shown in FIG. 16B, there is an area 1608 of the output frame that is to be partially updated as a consequence of the changes. In this embodiment, the area 1608 has a row start address (ST_ROW_ADD) of rowM, a row end address (E_ROW_ADD) of rowN, a column start address (ST_COL_ADD) of colP, and a column end address (E_COL_ADD) of colQ.

FIG. 17 then shows an example of a timing diagram for the output frame data signals 1504 and the partial update control signals 1506 for partially updating the output frame being displayed.

As is shown in FIG. 17, at the start of the new output frame, the vertical synchronisation signal (VSYNC) goes low and the first horizontal synchronisation signal (HSYNC) goes high. As is also shown in FIG. 17, to perform a partial update of the output frame currently being displayed, the partial update enable signal (PARTIAL_UPDATE_CFG) goes high, sufficient horizontal synchronisation signals (HSYNC) are provided for the lines of pixels of the partial update area, and the partial update area addresses (ST_ROW_ADD, E_ROW_ADD, ST_COL_ADD, E_COL_ADD) for the partial update area are provided. As is also shown in FIG. 17 in closer detail, for each line of pixels (i.e. each HSYNC), the data enable signal (DATA_EN) goes high and the relevant pixel data (PXLDATA) for the partial update area is provided in synchronisation with a clock signal (PXLCLK).

In other embodiments, rather than partially updating the display device 618 as part of the method of FIG. 10 (see steps 1024 and 1028) or FIG. 14 (see step 1420 or 1428), the display controller may partially update a frame buffer in memory 616. That partially updated frame buffer can then be read back in by the display controller 610 and output to the display device 618 for display. That partially updated frame buffer can also or instead be read in by the video engine 606, encoded by the video engine 606, and then output (e.g. wirelessly) to the display device 618 or another display device for display.

It can be seen from the above that the technology described herein, in its embodiments at least, can help to reduce, for example, display operation power consumption and memory bandwidth.

This is achieved, in the some embodiments of the technology described herein at least, by identifying opportunities to use lower display update rates and/or less expensive frame buffer formats and/or partial output frame updates, etc., by comparing output frames to determine whether the output frames or parts thereof are changing or not. Then, for example, if the output frame or a part thereof is only changing slowly or is static, the display or a frame buffer is updated at a lower rate and/or partially updated, thereby reducing power consumption and bandwidth. For another example, if the output frame is changing rapidly, the image quality is reduced, thereby again reducing power consumption and bandwidth.

The technology described herein, in some embodiments at least, can also or instead significantly reduce the frame buffer and display controller power consumption and frame buffer bandwidth requirements. For example, when the display update rate is being controlled, the frame buffer access power saving is expected to be around 50% when the image is static.

For example, a 32-bit mobile DDR-SDRAM transfer consumes about 2.4 nJ per 32-bit transfer. Thus, assuming a display update rate of 60 Hz, display refresh transactions will consume about (1920×1080×4)×2.4 nJ/4×60=300 mW and 474 MB/s for HD graphics at 60 fps and (1024×768×4)×(2.4 nJ/4)×60=112 mW and 180 MB/s for 1024×768 graphics at 60 fps.

Considering just the first order effect of frame buffer accesses and ignoring on-chip interconnect, display control and video output power consumption, etc., if the display refresh rate is reduced from 60 fps to 20 fps, that will save of the order of 200 mW and 316 MB/s for HD graphics and 75 mW and 120 MB/s for 1024×768 graphics.

Thus the technology described herein is particularly applicable for use with lower powered devices and devices where power consumption is important. It is therefore particularly applicable for use in or with mobile and portable devices.

1. A method of operating a data processing system in which a stream of output frames to be displayed is generated by the data processing system for display on a display device, the method comprising:
a display controller of the data processing system comparing output frames to be displayed, and controlling at least one aspect of the way in which the output frames are provided for display on the display device on the basis of the comparison.

2. The method of claim 1, comprising the display controller updating only part of the frame displayed on the display device or stored in a frame buffer on the basis of the comparison.

3. The method of claim 1, wherein the display controller generates composited output frames to be displayed from plural input layers generated by the data processing system, wherein the comparison comprises the display controller comparing the composited output frames to be displayed, and wherein the display controller controls at least one aspect of the way in which the composited output frames are provided for display on the display device on the basis of the comparison of the composited output frames.

4. The method of claim 3, further comprising the display controller buffering part of a current composited output frame to be displayed and either outputting or not outputting that part of the current composited output frame for display on the basis of the comparison of the composited output frames.

5. The method of claim 1, wherein the display controller generates composited output frames to be displayed from plural input layers generated by the data processing system, wherein the comparison comprises the display controller comparing input layers generated by the data processing system that form the composited output frames to be displayed, and wherein the display controller controls at least one aspect of the way in which the composited output frames are provided for display on the display device on the basis of the comparison of the input layers.

6. The method of claim 1, wherein comparing the output frames to be displayed comprises the display controller comparing line portions, groups of line portions or blocks of data representing particular regions of the respective output frames with each other.

7. The method of claim 6, wherein the step of comparing the output frames to be displayed comprises the display controller generating and comparing information representative of the content of the respective line portions, groups of line portions, or blocks of data.

8. A data processing system in which a stream of output frames to be displayed is generated by the data processing system for display on a display device, the system comprising:
a display device configured to display an output frame; and
a display controller comprising processing circuitry configured to compare output frames to be displayed and control at least one aspect of the way in which the output frames are provided for display on the display device on the basis of the comparison.

9. The system of claim 8, wherein the display controller comprises processing circuitry configured to update only part of the frame displayed on the display device or stored in a frame buffer on the basis of the comparison.

10. The system of claim 8, wherein the display controller comprises processing circuitry configured to generate composited output frames to be displayed from plural input layers generated by the data processing system, and wherein the display controller comprises processing circuitry configured to compare the composited output frames to be displayed, and control at least one aspect of the way in which the composited output frames are provided for display on the display device on the basis of the comparison of the composited output frames.

11. The system of claim 10, wherein the display controller further comprises a buffer configured to buffer part of a current composited output frame to be displayed, the display controller further comprising processing circuitry configured to either output or not output that part of the current composited output frame for display on the basis of the comparison of the composited output frames.

12. The system of claim 8, wherein the display controller comprises processing circuitry configured to generate composited output frames to be displayed from plural input layers generated by the data processing system, and wherein the display controller comprises processing circuitry configured to compare input layers generated by the data processing system that form the composited output frames to be displayed, and control at least one aspect of the way in which the composited output frames are provided for display on the display device on the basis of the comparison of the input layers.

13. The system of claim 8, wherein the display controller comprises processing circuitry configured to compare the output frames to be displayed by comparing line portions, groups of line portions or blocks of data representing particular regions of the respective output frames with each other.

14. The system of claim 13, wherein the display controller comprises processing circuitry configured to compare the output frames to be displayed by generating and comparing information representative of the content of the respective line portions, groups of line portions or blocks of data.

15. A display controller for use in a data processing system in which a stream of output frames to be displayed are generated by the data processing system for display on a display device, the display controller comprising:
processing circuitry configured to compare output frames to be displayed, and to control at least one aspect of the way in which the output frames are provided for display on the display device on the basis of the comparison.

16. The display controller of claim 15, wherein the display controller comprises processing circuitry configured to update only part of the frame displayed on the display device or stored in a frame buffer on the basis of the comparison.

17. The display controller of claim 15, wherein the display controller comprises processing circuitry configured to generate composited output frames to be displayed from plural input layers generated by the data processing system, and wherein the display controller comprises processing circuitry configured to compare the composited output frames to be displayed, and control at least one aspect of the way in which the composited output frames are provided for display on the display device on the basis of the comparison of the composited output frames.

18. The display controller of claim 17, wherein the display controller further comprises a buffer configured to buffer part of a current composited output frame to be displayed, the display controller further comprising processing circuitry configured to either output or not output that part of the current composited output frame for display on the basis of the comparison of the composited output frames.

19. The display controller of claim 15, wherein the display controller comprises processing circuitry configured to generate composited output frames to be displayed from plural input layers generated by the data processing system, and wherein the display controller comprises processing circuitry configured to compare input layers generated by the data processing system that form the composited output frames to be displayed, and control at least one aspect of the way in which the composited output frames are provided for display on the display device on the basis of the comparison of the input layers.

20. The display controller of claim 15, wherein the display controller comprises processing circuitry configured to compare the output frames to be displayed by comparing line portions, groups of line portions or blocks of data representing particular regions of the respective output frames with each other.

21. The display controller of claim 20, wherein the display controller comprises processing circuitry configured to compare the output frames to be displayed by generating and comparing information representative of the content of the respective line portions, groups of line portions or blocks of data.

22. A non-transitory computer readable storage medium storing computer software code for performing the method of claim 1 when the computer software code is run on processing circuitry of a display controller.
